(19) United States
(12) Patent Application Publication
(10) Pub. No.: US 2016/0229962 A1
(43) Pub. Date: Aug. 11, 2016

(54) SILICONE CHAIN EXTENDER

(71) Applicant: DANMARKS TEKNISKE UNIVERSITET, Kgs. Lyngby (DK)

(72) Inventors: Frederikke Bahrt, Frederiksberg (DK); Anders Egede Daugaard, Søborg (DK); Søren Hvilsted, Hørsholm (DK); Anne Ladegaard Skov, Frederiksberg (DK)

(21) Appl. No.: 15/026,129

(22) PCT Filed: Jul. 11, 2014
(86) PCT No.: PCT/EP2014/064932

§ 371 Date: Mar. 30, 2016

(30) Foreign Application Priority Data
Sep. 30, 2013 (EP) 13186588.3

(51) Int. Cl. C08G 77/26; C09D 183/08; C07F 7/08

(52) U.S. Cl. CPC C08G 77/26; C07F 7/0854; C07F 7/0889; C07F 7/0881; C09D 183/08

(57) ABSTRACT

The present invention relates to a silicone chain extender, more particularly a chain extender for silicone polymers and copolymers, to a chain extended silicone polymer or copolymer and to a functionalized chain extended silicone polymer or copolymer, to a method for the preparation thereof and the use thereof.

### FIELD OF THE INVENTION

The present invention relates to a silicone chain extender. The present invention more particularly relates to a chain extender for silicone polymers and copolymers, to a chain extended silicone polymer or copolymer and to a functionalized chain extended silicone polymer or copolymer, to a method for the preparation thereof and the use thereof.

### BACKGROUND OF THE INVENTION

Silicone elastomers are very versatile and are broadly applied due to their flexibility, solvent and wear resistance amongst other favorable properties. Silicone elastomers, such as in particular polydimethylsiloxane (PDMS), thus find application as e.g. adhesives, membranes, dielectric elastomers and biomedical applications. Its many excellent properties are ascribed to the presence of methyl groups along the flexible Si—O—Si backbone which gives the elastomers high thermal stability, high gas permeability, low surface tension and chemical and biological inertness.

Due to the many excellent properties of silicone elastomers it would be of great interest to extend the range of applications even further. The possibility of incorporating functionalities into silicone elastomer networks has been explored.

Bahrt Madsen et al., Novel cross-linkers for PDMS networks for controlled and well distributed grafting of functionalities by click chemistry, Polym. Chem., 2013, 4, 1700-1707 discloses an azide-containing, trifunctional vinyl cross-linker for silicone networks.

Gonzaga et al., Morphology-Controlled Synthesis of Poly(oxyethylene)silicone or Alkylsilicone Surfactants with Explicit, Atomically Defined, Branched, Hydrophobic Tails, Chem. Eur. J. 2012, 18, 1536-1541 discloses the preparation of trifunctional silicones linked via a “click” reaction to a hydrophile, such as PEG (poly(oxyethylene)).

Zhang et al, Modular Synthesis of Polyferrocenylsilane Block Copolymers by Cu-Catalyzed Alkyne/Azide “Click” Reactions, Macromolecules 2013, 46, 1296-1304, see also “Supporting Information” discloses the preparation of polyferrocenylsilane (PFS) block copolymers. The use of CuAAC “click” chemistry to expand the accessibility of macromolecular materials with novel functionality is mentioned.

U.S. Pat. No. 8,097,639 B2 and U.S. Pat. No. 8,022,157 B2 relate to a surface functionalized poly(dimethylsiloxane) (PDMS) which is said to be applicable in the field of microfluidics, bioMEMS, soft lithography and the like.

WO 2009/141738 A2 relates generally to methods of chemically modifying drugs that are resistant or incapable of being encapsulated in liposomes to form derivatives that can be loaded into liposomal nanoparticles.

Silicone elastomers are, however, difficult to modify chemically, and the preparation of functionalized silicone elastomers generally relies on the commercially available reactive PDMS polymers or copolymers where usually the functionalizable handles are either in excess or limited to a few leading either to uncontrolled grafting or too low concentration of grafted moieties, respectively. Furthermore it is usually very difficult to ensure efficient mixing of reactive non-silicone substances into the silicone matrix which may lead to poor reaction conversion and inhomogeneous substances.

### OBJECT OF THE INVENTION

It is an object of embodiments of the invention to provide a method that allows for specific grafting of moieties onto a silicone polymer or copolymer in a controlled way. It is a further object of embodiments of the invention to provide a chain extender for a silicone polymer or copolymer in order to allow a tailoring of silicone elastomers for a specific use. It is a further object of embodiments of the invention to provide a functionalized silicone polymer or copolymer, which may be produced by a reliable, simple and stable method of production.

### SUMMARY OF THE INVENTION

It has been found by the present inventor(s) that through the use of a novel chain extender for a silicone polymer or copolymer according to the invention a high loading of functionalizable moieties has been made possible. The present invention allows a flexible tailoring of the eventual silicone elastomer for any desired application of the elastomer in question.

So, in a first aspect the present invention relates to a compound of formula I:

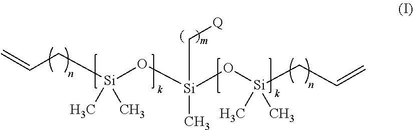

wherein Q is selected from the group consisting of —C≡CH, —N₃, —CN, halogen, —OH, —SH, —NH₂, —NO₂, —NCO, alkyl, alkenyl, alkynyl, cycloalkyl, cycloalkenyl, heterocycloalkyl, aryl, heteroaryl, aminoalkyl, alkoxy, —COOR, —O—C(═O)—R, —NH—C(═O)—R, —C(═O)—NH—R, —NH—C(═O)—O—R, —SO₃R, —O—(O═)₂S—R, and —P(═O)(OR)₂, wherein R is selected from the group consisting of H, alkyl, alkenyl, alkynyl, cycloalkyl, cycloalkenyl, heterocycloalkyl, aryl, and heteroaryl; wherein said alkyl, alkenyl, alkynyl, cycloalkyl, cycloalkenyl, heterocycloalkyl, aryl, heteroaryl, aminoalkyl, alkoxy, —COOR, —O—C(═O)—R, —NH—C(═O)—R, —C(═O)—NH—R, —NH—C(═O)—O—R, —SO₃R, —O—(O═)₂S—R, and —P(═O)(OR)₂ may be substituted by one or more substituents independently selected from the group consisting of —N₃, —CN, —Cl, —Br, —I, —OH, —SH, —NH₂, —NO₂, —NCO, C₁₋₆-alkyl, C₂₋₆-alkenyl and C₂₋₆-alkynyl;
k is an integer selected from the range of 1-3;
m is an integer selected from the range of 1-6; and
n is an integer independently selected from the range of 0-6.

In a second aspect the present invention relates to a chain extended silicone polymer or copolymer of the formula II comprising:

CEₚ-[SP-CE]ₒ-SP₍₁₋ₚ₎ (II)

wherein CE is a chain extender moiety of the formula (III),

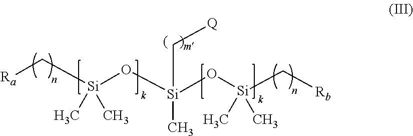

wherein Q is selected from the group consisting of —C≡CH, —N₃, —CN, halogen, —OH, —SH, —NH₂, —NO₂, —NCO, alkyl, alkenyl, alkynyl, cycloalkyl, cycloalkenyl, heterocycloalkyl, aryl, heteroaryl, aminoalkyl, alkoxy, —COOR, —O—C(═O)—R, —NH—C(═O)—R, —C(═O)—NH—R, —NH—C(═O)—O—R, —SO₃R, —O—(O═)₂S—R, and —P(═O)(OR)₂, wherein R is selected from the group consisting of H, alkyl, alkenyl, alkynyl, cycloalkyl, cycloalkenyl, heterocycloalkyl, aryl, and heteroaryl; wherein said alkyl, alkenyl, alkynyl, cycloalkyl, cycloalkenyl, heterocycloalkyl, aryl, heteroaryl, aminoalkyl, alkoxy, —COOR, —O—C(═O)—R, —NH—C(═O)—R, —C(═O)—NH—R, —NH—C(═O)—O—R, —SO₃R, —O—(O═)₂S—R, and —P(═O)(OR)₂ may be substituted by one or more substituents independently selected from the group consisting of —N₃, —CN, halogen, —OH, —SH, —NH₂, —NO₂, —NCO, C₁₋₆-alkyl, C₂₋₆-alkenyl and C₂₋₆-alkynyl;
Rₐ and R_{b} are the same and are selected from the group consisting of H, C₁₋₆alkyl, C₁₋₆alkoxy and C₂₋₆alkenyl;
k is an integer selected from the range of 1-3;
m′ is an integer selected from the range of 0-6; and
n is an integer independently selected from the range of 0-6;
SP is a silicone polymer or copolymer of the formula IV

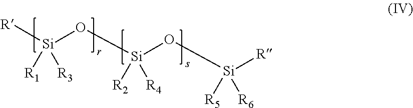

wherein each R₁, R₂, R₃, R₄, R₅ and R₆ is independently selected from the group consisting of —CN, halogen, —OH, —SH, —NH₂, —NO₂, —NCO, alkyl, alkenyl, alkynyl, cycloalkyl, cycloalkenyl, heterocycloalkyl, aryl, heteroaryl, aminoalkyl, alkoxy, —COOR, —O—C(═O)—R, —NH—C(═O)—R, —C(═O)—NH—R, —NH—C(═O)—O—R, —SO₃R, —O—(O═)₂S—R, and —P(═O)(OR)₂, wherein R is selected from the group consisting of H, alkyl, alkenyl, alkynyl, cycloalkyl, cycloalkenyl, heterocycloalkyl, aryl, and heteroaryl; wherein said alkyl, alkenyl, alkynyl, cycloalkyl, cycloalkenyl, heterocycloalkyl, aryl, heteroaryl, aminoalkyl, alkoxy, —COOR, —O—C(═O)—R, —NH—C(═O)—R, —C(═O)—NH—R, —NH—C(═O)—O—R, —SO₃R, —O—(O═)₂S—R, and —P(═O)(OR)₂ may be substituted by one or more substituents independently selected from the group consisting of —CN, —F, —Cl, —Br, I, —OH, —SH, —NH₂, —NO₂, —NCO, C₁₋₆-alkyl, C₂₋₆-alkenyl, and C₂₋₆-alkynyl;
r and s are integers selected from the range of 0-2500, wherein the sum of (r+s) is in the range of 1-2500;
o is an integer selected from the range of 0-1000, and
p is selected from the group consisting of 0 and 1;
and
R′ and R″ are absent or are selected from the group consisting of H, C₁₋₆alkyl, and C₂₋₆alkenyl.

In a third aspect the present invention relates to a functionalized, chain extended silicone polymer or copolymer of the formula (V)

CE(L-Y)ₚ-[SP-CE(L-Y)]ₒ-SP₍₁₋ₚ₎ (V)

wherein CE(L-Y) is a compound of the formula (VI),

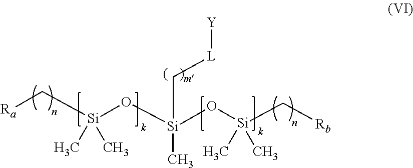

wherein Rₐ and R_{b} are the same and are selected from the group consisting of H, C₁₋₆alkyl, C₁₋₆alkoxy and C₂₋₆alkenyl;
k is an integer selected from the range of 1-3;
m′ is an integer selected from the range of 0-6; and
n is an integer independently selected from the range of 0-6;
L is a linker; and
Y is a functional group;
SP is a silicone polymer or copolymer of the formula (IV)

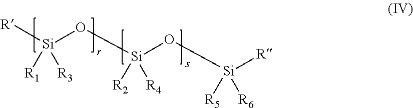

as defined above, o is an integer selected from the range of 0-1000, and p is selected from the group consisting of 0 and 1.

In a fourth aspect the present invention relates to a method of preparing a chain-extended silicone polymer or copolymer of the formula II

CEₚ-[SP-CE]ₒ-SP₍₁₋ₚ₎ (II)

comprising the step of reacting a compound CE of the formula III

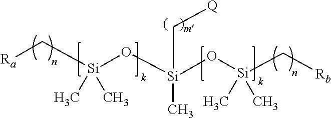

wherein Rₐ and R_{b} are the same and are selected from the group consisting of H, C₁₋₆alkyl, C₁₋₆alkoxy, and C₂₋₆alkenyl;
Q is selected from the group consisting of —C≡CH, —N₃, —CN, halogen, —OH, —SH, —NH₂, —NO₂, —NCO, alkyl, alkenyl, alkynyl, cycloalkyl, cycloalkenyl, heterocycloalkyl, aryl, heteroaryl, aminoalkyl, alkoxy, —COOR, —O—C(═O)—R, —NH—C(═O)—R, —C(═O)—NH—R, —NH—C(═O)—O—R, —SO₃R, —O—(O═)₂S—R, and —P(═O)(OR)₂, wherein R is selected from the group consisting of H, alkyl, alkenyl, alkynyl, cycloalkyl, cycloalkenyl, heterocycloalkyl, aryl, and heteroaryl; wherein said alkyl, alkenyl, alkynyl, cycloalkyl, cycloalkenyl, heterocycloalkyl, aryl, heteroaryl, aminoalkyl, alkoxy, —COOR, —O—C(═O)—R, —NH—C(═O)—R, —C(═O)—NH—R, —NH—C(═O)—O—R, —SO₃R, —O—(O═)₂S—R, and —P(═O)(OR)₂ may be substituted by one or more substituents independently selected from the group consisting of —N₃, —CN, halogen, —OH, —SH, —NH₂, —NO₂, —NCO, C₁₋₆-alkyl, C₂₋₆-alkenyl and C₂₋₆-alkynyl;
k is an integer selected from the range of 1-3;
m′ is an integer selected from the range of 0-6; and
n is an integer independently selected from the range of 0-6;
with a silicone polymer or copolymer SP of the formula IV

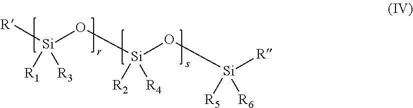

wherein each R₁, R₂, R₃, R₄, R₅ and R₆ is independently selected from the group consisting of —CN, halogen, —OH, —SH, —NH₂, —NO₂, —NCO, alkyl, alkenyl, alkynyl, cycloalkyl, cycloalkenyl, heterocycloalkyl, aryl, heteroaryl, aminoalkyl, alkoxy, —COOR, —O—C(═O)—R, —NH—C(═O)—R, —C(═O)—NH—R, —NH—C(═O)—O—R, —SO₃R, —O—(O═)₂S—R, and —P(═O)(OR)₂, wherein R is selected from the group consisting of H, alkyl, alkenyl, alkynyl, cycloalkyl, cycloalkenyl, heterocycloalkyl, aryl, and heteroaryl; wherein said alkyl, alkenyl, alkynyl, cycloalkyl, cycloalkenyl, heterocycloalkyl, aryl, heteroaryl, aminoalkyl, alkoxy, —COOR, —O—C(═O)—R, —NH—C(═O)—R, —C(═O)—NH—R, —NH—C(═O)—O—R, —SO₃R, —O—(O═)₂S—R, and —P(═O)(OR)₂ may be substituted by one or more substituents independently selected from the group consisting of —CN, —F, —Cl, —Br, I, —OH, —SH, —NH₂, —NO₂, —NCO, C₁₋₆-alkyl, C₂₋₆-alkenyl, and C₂₋₆-alkynyl;
r and s are integers selected from the range of 0-2500, wherein the sum of (r+s) is in the range of 1-2500;
o is an integer selected from the range of 0-1000, and
p is selected from the group consisting of 0 and 1; and
R′ and R″ are absent or are selected from the group consisting of H, C₁₋₆alkyl, and C₂₋₆alkenyl.

In a fifth aspect the present invention relates to a method of preparing a functionalized, chain extended silicone polymer or copolymer of the formula V:

CE(L-Y)ₚ-[SP-CE(L-Y)]ₒ-SP₍₁₋ₚ₎ (V)

said method comprising the step of reacting a chain extended silicone polymer or copolymer of the formula II

CEₚ-[SP-CE]ₒ-SP₍₁₋ₚ₎ (II)

with a compound of the formula (VII)

X—Y (VII)
wherein X is selected from the group consisting of —C≡CH, —N₃, —COOH, —OH, —SH, —NH₂, —SO₂, —PO₃, alkyl, cycloalkyl, heterocycloalkyl, aryl and heteroaryl, wherein said alkyl, cycloalkyl, heterocycloalkyl, aryl, heteroaryl may be substituted by one or more substituents selected from the group consisting of —CN, —F, —Cl, —Br, —I, —OH, —SH, —NH₂, —NO₂, —NCO, C₁₋₆-alkyl, C₂₋₆-alkenyl, and C₂₋₆-alkynyl; and
Y is a functional group;
or X and Y taken together form NR⁷R⁸R⁹, wherein R⁷, R⁸ and R⁹ are alkyl, or X and Y together form a cycloalkyl, heterocycloalkyl or heteroaryl group, wherein said alkyl, cycloalkyl, heterocycloalkyl or heteroaryl group may be substituted by one or more substituents selected from the group consisting of —CN, —F, —Cl, —Br, I, —OH, —SH, —NH₂, —NO₂, —NCO, C₁₋₆-alkyl, C₂₋₆-alkenyl, and C₂₋₆-alkynyl;
   to obtain the functionalized chain extended silicone polymer or copolymer of the formula (V).

In a sixth aspect the present invention relates to a method for preparing a crosslinked silicone elastomer comprising the step of reacting a chain extended silicone polymer or copolymer according to the invention with a crosslinker in a manner known per se.

In a seventh aspect the present invention relates to a method for preparing a crosslinked silicone elastomer comprising the steps of reacting a chain extender according to the invention, a silicone polymer or copolymer according to the invention, and a crosslinker in a manner known per se.

In a eighth aspect the present invention relates to a method for preparing a crosslinked functionalized silicone elastomer comprising the step of reacting a functionalized silicone polymer or copolymer according to the invention with a crosslinker in a manner known per se.

In a ninth aspect the present invention relates to a use of a crosslinked functionalized chain extended silicone elastomer as electroactive elastomer.

### LEGENDS TO THE FIGURE

FIG. 1 shows the relative dielectric permittivity (E′) and loss tangent (tan δ) as functions of frequency for elastomer film 1.f;

FIG. 2 shows the relative dielectric permittivity (E′) and loss tangent (tan δ) as functions of frequency for elastomer films 2.d with different amounts of a commercially available silicone elastomer system within;

FIG. 3 shows the relative dielectric permittivity (E′) and loss tangent (tan δ) as functions of frequency for elastomer films 3.e, 3.f, 3.g-1 (low concentration of nitrobenzene functionality), 3.g-2 (medium concentration of nitrobenzene functionality) and 3.g-3 (high concentration of nitrobenzene functionality);

FIG. 4 shows the relative dielectric permittivity (E′) and loss tangent (tan δ) as functions of frequency for elastomer films 4.f, 4.g, 4.h-1 (low concentration of nitrobenzene functionality), 4.h-2 (medium concentration of nitrobenzene functionality) and 4.h-3 (high concentration of nitrobenzene functionality); and

FIG. 5 shows the relative dielectric permittivity (E′) and loss tangent (tan δ) as functions of frequency for elastomer film 4.i.

### DETAILED DISCLOSURE OF THE INVENTION

### Definitions

In the present context, the term “alkyl” is intended to indicate a radical obtained when one hydrogen atom is removed from a hydrocarbon. Said alkyl comprises 1-24, such as 1-12, such as 1-10, preferably 1-8, such as 1-6, such as 1-4, such as 1-3, such as 1-2 carbon atoms or 2-3 carbon atoms. The term includes the subclasses normal alkyl (n-alkyl), secondary and tertiary alkyl, such as methyl, ethyl, n-propyl, isopropyl, n-butyl, isobutyl, sec.-butyl, tert.-butyl, pentyl, isopentyl, hexyl and isohexyl.

The term “alkenyl” is intended to indicate a radical containing at least one C═C double bond. Said alkenyl comprises 2-24, such as 2-12, such as 2-10, preferably 2-8, such as 2-6, such as 2-4, such as 2-3 carbon atoms. Non-limiting exemplary alkynyl groups comprise ethenyl, propenyl and n-butenyl.

The term “alkynyl” is intended to indicate a radical containing at least one C≡C triple bond. Said alkynyl comprises 2-24, such as 2-12, such as 2-10, preferably 2-8, such as 2-6, such as 2-4, such as 2-3 carbon atoms. Non-limiting exemplary alkynyl groups comprise ethynyl, propynyl and n-butynyl.

The term “cycloalkyl” is intended to indicate a saturated cycloalkane radical comprising 3-12 carbon atoms, preferably 3-10 carbon atoms, in particular 3-8 carbon atoms, such as 3-6 carbon atoms or 3-5 carbon atoms, including fused bicyclic rings or bridged bicyclic or tricyclic rings, e.g. cyclopropyl, cyclobutyl, cyclopentyl, cyclohexyl, or cycloheptyl.

The term “cycloalkenyl” is intended to indicate a mono-unsaturated cycloalkane radical comprising 3-12 carbon atoms, preferably 3-10 carbon atoms, in particular 3-8 carbon atoms, such as 3-6 carbon atoms or 3-5 carbon atoms, including fused bicyclic rings or bridged bicyclic or tricyclic rings, e.g. cyclopropenyl, cyclobutenyl, cyclopentenyl, cyclohexenyl, or cycloheptenyl.

The term “heterocycloalkyl” is intended to indicate a cycloalkane radical as described above, wherein one or more carbon atoms are replaced by heteroatoms, comprising 1-14 carbon atoms, e.g. 2-5 or 2-4 carbon atoms, further comprising 1-6 heteroatoms, preferably 1, 2, or 3 heteroatoms, selected from O, N, or S, e.g. piperidinyl, pyrrolidinyl, morpholinyl, tetrahydrofuranyl, tetrahydropyranyl, piperazinyl, [1,3]dioxolanyl and [1,3]dioxolyl, or including fused bicyclic rings with 1-4 heteroatoms, wherein at least one ring comprises a heteroatom, and wherein the other ring may for example be a carbocyclic ring, or including bridged carbocyclic rings, such as e.g. 1,4-diazabicyclo[2.2.2]octane or 1,6-diazabicyclo[4.2.2]decane.

The term “aryl” is intended to indicate a radical of aromatic carbocyclic rings comprising 6-14 carbon atoms, such as 6-10 carbon atoms or 6-9 carbon atoms, in particular 5- or 6-membered rings, including fused carbocyclic rings with at least one aromatic ring, such as phenyl, naphthyl, indenyl and indanyl.

The term “heteroaryl” is intended to indicate radicals of heterocyclic aromatic rings comprising 1-6 heteroatoms (selected from O, S and N) and 1-14 carbon atoms, such as 1-5 heteroatoms and 1-12 carbon atoms, such as 1-5 heteroatoms and 1-6 carbon atoms, such as 1-4 heteroatoms and 1-3 carbon atoms, in particular 5- or 6-membered rings with 1-4 heteroatoms selected from O, S and N, including fused bicyclic rings with 1-4 heteroatoms, and wherein at least one ring is aromatic, e.g. pyridyl, quinolyl, isoquinolyl, indolyl, thiadiazolyl, oxodiazolyl, tetrazolyl, furanyl, thiazolyl, benzooxazolyl, imidazolyl, pyrazolyl, triazolyl, oxazolyl, isoxazolyl, thienyl, pyrazinyl, isothiazolyl, benzimidazolyl, benzofuranyl and 6,7,8,9-tetrahydropyrido[2,3-b][1,6]naphthyridine.

The term “halogen” is intended to indicate a substituent from the 7^{th} main group of the periodic table, such as fluoro, chloro, bromo and iodo.

The term “haloalkyl” is intended to indicate an alkyl group as defined above substituted with one or more halogen atoms as defined above, e.g. fluoro or chloro, such as difluoromethyl, or trifluoromethyl.

The term “amino” is intended to indicate a substituent of the formula —NH₂.

The term “aminoalkyl” is intended to indicate an alkyl group as defined above substituted with one or more amino groups as defined above, such as aminomethyl, or diaminomethyl.

The term “alkoxy” is intended to indicate a radical of the formula —OR′, wherein R′ is alkyl as indicated above, e.g. methoxy, ethoxy, n-propoxy, isopropoxy, butoxy, etc.

The term “haloalkoxy” is intended to indicate a radical of the formula —OR′, wherein R′ is haloalkyl as indicated above, e.g. trifluoromethoxy or difluoromethoxy.

The term “hydroxyalkyl” is intended to indicate an alkyl group as defined above substituted with one or more hydroxy, e.g. hydroxymethyl, hydroxyethyl, hydroxypropyl.

The term “arylalkyl” is intended to indicate an alkyl radical as defined above, which is substituted with an aryl radical as defined above, e.g. benzyl, phenylethyl etc.

The term “heteroarylalkyl” is intended to indicate an alkyl radical as defined above, which is substituted with a heteroaryl radical as defined above, e.g. imidazolylmethyl, pyridinylethyl, etc.

The term “heterocycloalkylalkyl” is intended to indicate an alkyl radical as defined above, which is substituted with a heterocycloalkyl radical as defined above, e.g. tetrahydropyranylmethyl, piperazinylmethyl, piperidinylmethyl, etc.

The term “alkoxyalkyl” is intended to indicate an alkyl radical as defined above, which is substituted with an alkoxy radical as defined above, i.e. —R′—O—R′, wherein each R′ is alkyl, same or different, as indicated above, e.g. methoxymethyl, ethoxymethyl.

The term “isocyanate” is intended to indicate a radical of the formula O═C═N—.

The term “functional group” is intended to indicate a group imparting a desired functionality to a substance in question. Non-limiting examples of functional groups are biomedical groups, surface-modifying groups or groups providing electroactivity. More particular, non-limiting examples include a so-called push-pull nitro functionality, ionic compounds, e.g. ionic polyers or ionic liquids, fluorescent molecules, bioactive functionalities, e.g. PEGylation etc.

The term “functionalization” is intended to indicate the step of reacting a functional group as defined herein and a chain extender according to the invention or a chain extender moiety according to the invention.

### SPECIFIC EMBODIMENTS OF THE INVENTION

In an embodiment of the invention Q is selected from the group consisting of —C≡CH, —N₃, —F, —Cl, —Br, —I, —CN, —OH, —SH, —NH₂, —NO₂, —NCO, C₁₋₆-alkyl, C₂₋₆-alkenyl, C₂₋₆-alkynyl, C₃₋₆-cycloalkyl, C₃₋₆-cycloalkenyl, C₃₋₆-heterocycloalkyl, phenyl, naphthyl, imidazolyl, tetrazolyl, triazolyl, C₁₋₆-aminoalkyl, C₁₋₆-alkoxy, —COOR, —O—C(═O)—R, —NH—C(═O)—R, —C(═O)—NH—R, —NH—C(═O)—O—R, —SO₃R, —O—(O═)₂S—R, and —P(═O)(OR)₂, wherein R is selected from the group consisting of H, C₁₋₆-alkyl, C₂₋₆-alkenyl, C₂₋₆-alkynyl; wherein said C₁₋₆-alkyl, C₂₋₆-alkenyl, C₂₋₆-alkynyl, C₃₋₆-cycloalkyl, C₃₋₆-cycloalkenyl, C₃₋₆-heterocycloalkyl, phenyl, naphthyl, imidazolyl, tetrazolyl, triazolyl, C₁₋₆-aminoalkyl, C₁₋₆-alkoxy, —COOR, —O—C(═O)—R, —NH—C(═O)—R, —C(═O)—NH—R, —NH—C(═O)—O—R, —SO₃R, —O—(O═)₂S—R, and —P(═O)(OR)₂ may be substituted by one or more substituents independently selected from the group consisting of —N₃, —CN, —Cl, —Br, —OH, —SH, —NH₂, —NO₂, —NCO, C₁₋₆-alkyl, C₁₋₆-alkenyl and C₁₋₆-alkynyl.

In an embodiment of the invention Q is selected from the group consisting of —C≡CH, —N₃, —Cl, —Br, —I, —OH, C₁₋₆-alkyl, C₁₋₆-aminoalkyl, C₂₋₆-alkenyl, C₂₋₆-alkynyl, phenyl, naphthyl, imidazolyl, tetrazolyl, triazolyl, —O—C(═O)—R, and —NH—C(═O)—R, wherein R is C₁₋₆-alkyl or phenyl, wherein said C₁₋₆-alkyl, C₁₋₆-aminoalkyl, C₂₋₆-alkenyl, C₂₋₆-alkynyl, phenyl, naphthyl, imidazolyl, tetrazolyl, triazolyl, —O—C(═O)—R, and —NH—C(═O)—R is optionally substituted by one or more substituents independently selected from the group consisting of —N₃, —CN, —Cl, —Br, —OH, —SH, —NH₂, —NO₂, —NCO, C₁₋₆-alkyl, C₂₋₆-alkenyl, and C₂₋₆-alkynyl, preferably wherein Q is —Cl or —N₃. Thus in an embodiment of the invention Q is N₃ and the chain extender may be used to functionalize a silicone polymer or copolymer via the so-called “click chemistry”, such as an azide-alkyne cycloaddition between an azide and a terminal or internal alkyne to give a 1,2,3-triazole moiety.

In an embodiment of the invention each k is 1 or 2, preferably 1.

In an embodiment of the invention m is an integer selected from the range of 1-4, preferably m is 3.

In an embodiment of the invention each n is 0 or 1, preferably n is 0.

In an embodiment of the chain extended silicone polymer or copolymer according to the invention each R₁, R₂, R₃, and R₄ are selected from the group consisting of C₁₋₆alkyl and phenyl, and are preferably all methyl. Silicone polymers wherein each R₁, R₂, R₃, and R₄ are methyl include polydimethyl siloxanes (PDMS). Commercially available PDMS include hydride functional PDMS of the HMS-Hxx series, wherein xx=03-41 from Gelest.

In an embodiment of the chain extended silicone polymer or copolymer according to the invention r and s are each independently selected from the range of 0-100, preferably 0-20.

In an embodiment of the chain extended silicone polymer or copolymer according to the invention o is an integer selected from the range of 5-500, such as 10-200, such as 15-150, preferably 30-60.

In an embodiment of the invention for preparing a chain extended silicone polymer or copolymer of the formula (II) a chain extender moiety of the formula (III) is provided in a first step and reacted with a silicone polymer or copolymer of the formula (IV). The chain extended silicone polymer or copolymer of the formula (II) is optionally converted to another compound of the formula (II). Thus as a non-limiting example a chain extended silicone polymer or copolymer of the formula (II), wherein Q is halogen, such as —Cl, may be converted by standard methods as known in the art to the corresponding compound of the formula II, wherein Q is —N₃. As another non-limiting example a chain extended silicone polymer or copolymer of the formula (II), wherein Rₐ and R_{b} are C₁₋₆alkoxy, may be converted by standard methods to the corresponding compound of the formula (II), wherein Rₐ and R_{b} are H, C₁₋₆alkyl or C₂₋₆alkenyl.

In an embodiment of the invention the method of preparing a functionalized, chain extended silicone polymer or copolymer of the formula (V):

CE(L-Y)ₚ-[SP-CE(L-Y)]ₒ-SP₍₁₋ₚ₎ (V)

comprises the steps of:
a) Providing a chain extender of the formula (I) as defined above;
b) Reacting said compound of the formula (I) in either order with
   i) a silicone polymer or copolymer of the formula (IV) and
   ii) a compound of the formula (VII)

X—Y (VII)
wherein X is selected from the group consisting of —C≡CH, —N₃, —COOH, —OH, —SH, —NH₂, —SO₂, —PO₃, alkyl, cycloalkyl, heterocycloalkyl, aryl, heteroaryl, wherein said alkyl, cycloalkyl, heterocycloalkyl, aryl, heteroaryl may be substituted by one or more substituents selected from the group consisting —CN, —F, —Cl, —Br, —I, —OH, —SH, —NH₂, —NO₂, —NCO, C₁₋₆-alkyl, C₂₋₆-alkenyl, and C₂₋₆-alkynyl; and
Y is a functional group;
or X and Y taken together form NR⁷R⁸R⁹, wherein R⁷, R⁸ and R⁹ are alkyl, or X and Y together form a cycloalkyl, heterocycloalkyl or heteroaryl group, wherein said alkyl, cycloalkyl, heterocycloalkyl or heteroaryl group may be substituted by one or more substituents selected from the group consisting of —CN, —F, —Cl, —Br, I, —OH, —SH, —NH₂, —NO₂, —NCO, C₁₋₆-alkyl, C₂₋₆-alkenyl, and C₂₋₆-alkynyl;
   to obtain the functionalized silicone polymer or copolymer of formula (V), preferably wherein the chain extender of the formula (I) is reacted with a compound of the formula (VII) and subsequently with a silicone polymer or copolymer of the formula (IV).

In an embodiment of the invention for preparing a functionalized, chain extended silicone polymer or copolymer of the formula (V) a chain extender of the formula (I) is provided in a first step and optionally converted to another compound of the formula (I). Thus as a non-limiting example a chain extender of the formula (I), wherein Q is halogen, such as —Cl, may be prepared from commercially available reactants using standard methods as known in the art and converted by a standard method to the corresponding compound of the formula (I), wherein Q is —N₃.

In an embodiment of the functionalized, chain extended silicone polymer or copolymer according to the invention L is selected from the group consisting of a direct bond, heterocycloalkyl and heteroaryl, preferably being 1,2,3-triazolyl. Thus the linker L between the chain extender moiety of the formula (III) and the desired functional group Y is typically a reaction product of a compound of the formula (I) and a compound of the formula (VII). In a preferred embodiment of the invention said reaction is an azide-alkyne cycloaddition between an azide and a terminal or internal alkyne to give a 1,2,3-triazole moiety. The so-called “click chemistry” concept is typically an azide alkyne Huisgen cycloaddition using a Cu(I) catalyst or an activated alkyne (such as propiolate esters or cyclooctynes) at room temperature or at 40-60° C. In another embodiment of the invention ruthenium is used as catalyst for the reaction. In another embodiment of the invention the reaction takes place with or without a catalyst at an elevated temperature, such as a temperature in the range 80-180° C.

In another embodiment of the functionalized, chain extended silicone polymer or copolymer according to the invention L is a direct bond.

In an embodiment of the functionalized, chain extended silicone polymer or copolymer according to the invention Y is a functional group selected from the group consisting of a biomedical group, a group providing electroactivity, and a surface-modifying group.

It is contemplated that the functionalized chain-extended silicone polymers and copolymers according to the invention may be used for preparing e.g. silver-containing silicone elastomers for application in medicotechnical devices as tubings, implants, or as adhesives for wounds. It is further contemplated that the functionalized chain-extended silicone polymers and copolymers according to the invention may be used for preparing electroactive elastomers by introduction of a so-called push-pull nitro functionality in order to increase the dielectric permittivity or for preparing ferrocene-containing elastomers for enhancing the thermal stability of silicone elastomers.

It is also contemplated that ionic polymers or polymeric ionic liquids may be grafted onto a chain extended silicone elastomer, which could give the elastomer ion conducting properties or increase the solubilizing effects of different fillers in the elastomer. This would find applications in fuel cells or in the elastomer field where many different types of fillers are used.

If the elastomeric network itself is formed through ionic linkages the procedure can also be used for silicone elastomers with self-healing properties. Such materials could find applications in various products where the material is experiencing a high number of load cycles.

It is further contemplated that the optionally functionalized chain-extended silicone polymers and copolymers according to the invention may be labelled with either fluorescent molecules or dyes, which would enable visualization of the elastomer.

It is further contemplated that a bioactive functionality such as e.g. estradiol or L-lysine may be incorporated in order to increase the biocompatibility of the elastomer.

It is further contemplated that the surface properties of the elastomer may be tailored through grafting of different polymers onto the silicone after chain extension or crosslinking, respectively. Both approaches can be used to control the antibacterial, antifouling and general surface properties of the elastomer. Applications would primarily be in the medico industry with respect to the antibacterial and antifouling properties, but any application where the elastomer is exposed to biological materials or aqueous environments might benefit of a controlled interaction. The general surface properties of the elastomer would especially find applications in processing, where a specific release would be achievable.

Thus in an embodiment of the invention the step of functionalization of the silicone polymer or copolymer takes place before the step of crosslinking.

In another embodiment of the invention the step of functionalization of the silicone polymer or copolymer takes place after the step of crosslinking.

Examples of interesting functionalities are e.g. pegylation of the elastomer (through CuAAC with e.g. PEG-alkyne) which is expected to create hydrophilic elastomer surfaces. Such materials should have an increased biocompatibility and are generally considered the benchmarking for antifouling polymer surfaces; Introduction of short fluoropolymers (e.g. poly(pentafluorostyrene)) in order to increase the surface hydrophobicity due to increase of the silicone elastomer surface energy; or antifouling polymers based on oxazolines, phosphorylcholines, sulfobetaines, polyethyleneglycols, zwitterionic units in general which could be introduced and thereby specifically target a certain level of antifouling activity.

An embodiment of the invention is a method for preparing a crosslinked silicone elastomer comprising the steps of reacting a compound of formula I according to the invention, a chain-extended silicone polymer or copolymer of the formula (II) according to the invention or blends of any of these with a silicone polymer or copolymer of the formula (IV) as defined above with a crosslinker in a manner known per se in order to obtain a crosslinked elastomer. Thus in an embodiment of the invention a chain extender of formula (I), a chain-extended silicone polymer or copolymer of formula (II) or a blend of any of these with a silicone polymer or copolymer of the formula (IV) may be crosslinked in a manner known per se such as by a Pt catalyzed vinyl silane addition curing reaction, a metal salt catalyzed condensation, a peroxide catalyzed metal salt condensation, or a free-radical initiated reaction, such as a peroxide-radical reaction, cf. R. Yoda, Elastomers for biomedical applications, J. Biomater. Sci. Polymer Edn, Vol. 9, No. 6, pp 561-626 (1998), or a thiol-ene addition reaction, cf. Reza Arshady, “Introduction to polymeric biomaterials, The PBM Series ISSN 1479-1285, Volume 1, Van Dyke, Clarson, Arshady, p. 110-135. In an embodiment of the invention the crosslinked elastomer obtained is subsequently functionalized by reaction with a compound of the formula (VII). In another embodiment of the invention a chain extended polymer or copolymer is functionalized and subsequently crosslinked in a manner known per se.

An embodiment of the invention is a use of a crosslinked functionalized silicone elastomer as biomedical elastomer.

An embodiment of the invention is a use of a crosslinked silicone elastomer for surface modification of an elastomeric material.

The invention is disclosed in more detail with reference to the following non-limiting examples.

### EXAMPLES

### General Methods

FTIR was performed on a PerkinElmer Spectrum One Fourier Transform Infrared apparatus equipped with a universal attenuated total reflection (ATR) accessory on a ZnSe/diamond composite. Spectra were recorded in the range of 4000-650 cm⁻¹ with 4 cm⁻¹ resolution and 16 or 32 scans. ¹H- and ¹³C-NMR experiments were performed on a Bruker 250 MHz spectrometer. Size-exclusion chromatography (SEC) was performed on a Tosoh EcoSEC HLC-8320GPC instrument equipped with RI and UV detectors and SDV Linear S columns from PSS, Mainz, Germany. Samples were run in toluene at 35° C. at a rate of 1 mL min⁻¹ and molar mass characteristics were calculated using WinGPC Unity 7.4.0 software and linear polydimethylsiloxane (PDMS) standards acquired from PSS, Mainz, Germany. Dielectric relaxation spectroscopy (DRS) was performed on a Novocontrol Alpha-A high performance frequency analyzer (Novocontrol Technologies GmbH & Co. KG, Germany) operating in the frequency range 10⁻¹-10⁶ Hz at room temperature. The diameter of the samples tested was 25 mm.

### General Procedure for Elastomer Synthesis

A given polymer (2.33 g, 10.1 mmol) and 8-functional cross-linker (HMS-301, 0.066 g, 0.034 mmol) were mixed with treated silica particles (0-20 wt %) and the mixture was mixed on a FlackTek Inc. DAC 150.1 FVZ-K SpeedMixer™. The platinum catalyst (511, Hanse Chemie) (1-100 ppm) was added hereafter and the mixture was once more mixed on the speedmixer. The mixture was poured into 1 mm thick steel molds on a fluorinated ethylene propylene (FEP) release liner and furthermore coated as 150 μm films on a glass substrate and cured at 115° C.

### Materials

Hydride-terminated PDMS, DMS-H11 (M̅_{w}˜1200 g mol⁻¹ as determined by ¹H-NMR), 3-(chloropropyl)methyldimethoxysilane, allyldimethysilane, 8-functional hydride-cross-linker, HMS-301, and 16-functional vinyl crosslinker, VDT-431 were acquired from Gelest Inc. Hydride-terminated PDMS, (M̅_{w}˜580 g mol⁻¹ as stated by supplier) was purchased from Sigma-Aldrich. The platinum cyclovinylmethyl siloxane complex catalyst (511) was purchased from Hanse Chemie. Silicon dioxide amorphous hexamethyldisilazane treated particles (SIS6962.0) were acquired from Fluorochem. Commercial silicone elastomer system POWERSIL® XLR® 630 A/B LSR was purchased from Wacker Chemie AG. All other chemicals were acquired from Sigma-Aldrich and used as received unless otherwise specified.

### Example 1

All reactions are performed under nitrogen.

### 1.a

### 1,5-diallyl-3-(chloromethyl)-1,1,3,5,5-pentamethyltrisiloxane

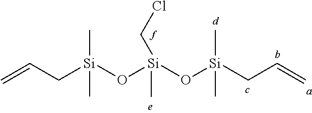 [SMILES: C=CC[Si](C)(C)O[Si](C)(CCl)O[Si](C)(C)CC=C]

Chloromethyl(methyl)dimethoxysilane (3.00 g, 19.4 mmol) was dissolved in dry heptane (30 ml) in a 250 ml 2-necked round bottomed flask. Allyldimethylsilane (5.83 g, 58.2 mmol) was added and the mixture was stirred for 5 min. Tris(pentafluorophenyl)borane (240 μl, 0.04 M, 9.38 μmol) in dry toluene (2 ml) was added and methane gas was developed. The mixture was stirred at RT for 1 h where after neutral aluminum oxide (3 g) was added to remove the tris(pentafluorophenyl)borane catalyst. The reaction mixture was now filtered and solvent and excess reagent were removed in vacuo to give the product as a clear oil (89%). IR (cm⁻¹): 2960 (C—H stretch); 1630 (C═C stretch); 1255 (Si—CH₃ stretch); 1055 (Si—O stretch). ¹H NMR (CDCl₃, δ_{H}, ppm): 0.13-0.17 (m, 15H, CH₃—Si), 1.60 (d, 4H, ²J=8 Hz, Si(CH₃)₂—CH₂—CH), 2.62 (s, 2H, Cl—CH₂—Si), 4.85-4.92 (m, 4H, CH═CH₂), 5.80 (m, 2H, —CH═CH₂). ¹³C-NMR (CDCl₃, δ_{C}, ppm): −2.26 (e), −0.34 (d), 26.05 (c), 29.49 (f), 113.66 (a), 133.96 (b).

### 1.b

### 1,5-diallyl-3-(azidomethyl)-1,1,3,5,5-pentamethyltrisiloxane

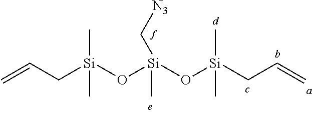 [SMILES: C=CC[Si](C)(C)O[Si](C)(CN=[N+]=[N-])O[Si](C)(C)CC=C]

1.a (6.3 g, 19.5 mmol) and NaN₃ (1.7 g, 24.0 mmol) were dissolved in DMF (20 ml) in a 50 ml 2-necked round bottomed flask. The reaction mixture was stirred at 45° C. for 18 hours. The reaction mixture was quenched with H₂O (40 ml) and extracted with heptane (5×40 ml). The organic phases were combined and washed with H₂O (3×40 ml) and brine (1×40 ml), dried with MgSO₄, filtered and concentrated in vacuo to give the product in the form of a clear oil (6.1 g, 95%). IR (cm⁻¹): 2960 (C—H stretch); 2095 (—N₃ stretch); 1630 (C═C stretch); 1255 (Si—CH₃ stretch); 1055 (Si—O stretch). ¹H NMR (CDCl₃, δ_{H}, ppm): 0.07-0.14 (m, 15H, CH₃—Si), 1.60 (d, 4H, ²J=8 Hz, Si(CH₃)₂—CH₂—CH), 2.63 (s, 2H, N₃—CH₂—Si), 4.86-4.93 (m, 4H, CH═CH₂), 5.80 (m, 2H, —CH═CH₂). ¹³C-NMR (CDCl₃, δ_{C}, ppm): −1.11 (e), −0.32 (d), 26.04 (c), 41.15 (f), 113.76 (a), 133.83 (b).

### 1.c

### 1-((1,5-diallyl-1,1,3,5,5-pentamethyltrisiloxan-3-yl)methyl-4-(4-nitrophenyl)-1H-1,2,3-triazole

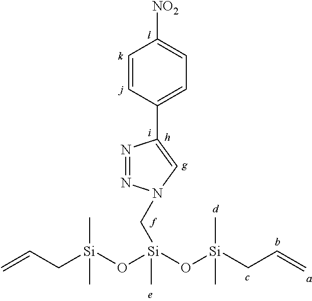 [SMILES: C=CC[Si](C)(C)O[Si](C)(Cn1cc(-c2ccc([N+](=O)[O-])cc2)nn1)O[Si](C)(C)CC=C]

1.b (3 g, 9.1 mmol) and 1-ethynyl-4-nitrobenzene (1.4 g, 9.6 mmol) were dissolved in dry THF (150 ml) in a 250 ml 2-necked round bottomed flask. The mixture was stirred for 5 min. CuI (0.18 g, 0.96 mmol) was subsequently added, the mixture was stirred again for 5 min and Et₃N (1.45 g, 14.3 mmol) was added dropwise. The reaction was carried out at RT for 24 hours then at 40° C. for 22 h. The reaction mixture was extracted with/heptane and washed with H₂O (3×100 ml) and brine (1×100 ml), dried with MgSO₄, filtered and concentrated in vacuo. The product was hereafter washed with diethylether and filtered to give a red solid (1.2 g, 28%). IR (cm⁻¹): 3080 (aromatic=C—H stretch); 2960-2910 (C—H stretch); 1630 (C═C stretch); 1605 (aromatic C═C stretch); 1515 (N═O asymmetric stretch); 1455 (aromatic C═C stretch); 1335 (N═O symmetric stretch); 1255 (Si—CH₃ stretch); 1060 (C—O stretch); 1040 (Si—O stretch). ¹H NMR (CDCl₃, δ_{H}, ppm): 0.11-0.12 (m, 12H, CH₃—Si), 0.24 (s, 3H, CH₃—Si), 1.57 (d, 4H, ²J=8 Hz, Si(CH₃)₂—CH₂—CH), 3.90 (s, 2H, N—CH₂—Si), 4.85-4.91 (m, 4H, CH═CH₂), 5.75 (m, 2H, —CH═CH₂), 7.83 (s, 1H, —C═CH—N—), 7.98 (d, 2H, ³J=9 Hz, Ar—H), 8.39, (d, 2H, ³J=9 Hz, NO₂—Ar—H). ¹³C-NMR (CDCl₃, δ_{C}, ppm): −0.88 (e), −0.32 (d), 25.87 (c), 41.85 (f), 114.08 (a), 121.78 (g), 124.33 (k), 125.91 (j), 133.49 (b) 137.21 (i), 145.31 (l), 147.16 (h).

### 1.d

Chain Extension to ˜30,000 g mol⁻¹:

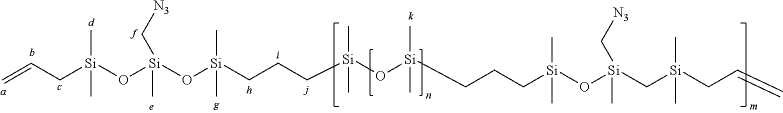

1.b (0.89 g, 2.7 mmol) and hydride-terminated PDMS (DMS H-11) (3.1 g, 2.8 mmol) was dissolved in dry THF (5 ml) in a 50 ml 2-necked round bottomed flask. The platinum cyclovinylmethyl siloxane complex catalyst (511) (150 μl of a 0.04 g/ml solution in THF) was added drop wise. The reaction mixture was stirred overnight at 55° C. After the chain extension reaction, the reaction mixture was diluted with 20 ml dry THF and end-capped with 1.b (0.21 g, 0.64 mmol) overnight at 55° C. The chain extended PDMS with vinyl end groups were now precipitated in dry methanol, which was hereafter decanted. The PDMS was dried overnight at RT to give a transparent oil (3.26 g 81.1%). IR (cm⁻¹): 2960 (C—H stretch); 2095 (—N₃ stretch); 1630 (C═C stretch); 1255 (Si—CH₃ stretch); 1015 (Si—O stretch). ¹H NMR (CDCl₃, δ_{H}, ppm): 0.05-0.12 (m, 3300H, CH₃—Si), 0.62 (m, 230H, —CH₂—Si), 1.82 (dd, 4H, ³J=6 Hz and ⁴J=1.5 Hz, Si(CH₃)₂—CH₂—CH), 2.60 (s, 52H, N₃—CH₂—Si), 5.64 (m, 4H, CH═CH₂), 6.14 (m, 2H, —CH═CH₂). ¹³C-NMR (CDCl₃, δ_{C}, ppm): −1.06-1.17 (d, e, g, k) 17.06 (h, j) 22.65 (i), 41.28 (f) (a, b and c not visible). SEC: M̅_{w}=33,100 g mol⁻¹, M̅_{w}/M̅ₙ, =4.51.

### 1.e

### Synthesis of Functionalized Polymer

### Click Reaction on 1.d:

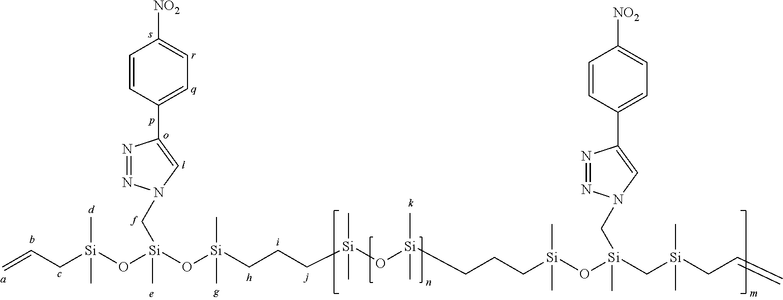

1.d (2.74 g, 1.97 mmol) and 1-ethynyl-4-nitrobenzene (0.305 g, 2.1 mmol) were dissolved in dry THF (20 ml) in a 250 ml 2-necked round bottomed flask. The mixture was stirred for 5 min. CuI (0.04 g, 0.21 mmol) was subsequently added, the mixture was stirred again for 5 min and Et₃N (0.31 g, 3.1 mmol) was added dropwise. The reaction was carried out at 45° C. for 22 h. The functionalized chain extended PDMS with vinyl end groups were now precipitated in dry methanol, which was hereafter decanted. The PDMS was dried overnight at RT to give a red oil in quantitative yield. IR (cm⁻¹): 2960 (C—H stretch); 1605 (aromatic C═C stretch); 1520 (N═O asymmetric stretch); 1340 (N═O symmetric stretch); 1255 (Si—CH₃ stretch); 1010 (Si—O stretch). ¹H NMR (CDCl₃, δ_{H}, ppm): 0.03-0.21 (m, CH₃—Si), 0.61 (m, —CH₂—Si), 1.38 (m, CH₂—CH₂—CH₂), 1.79 (d, 4H, ³J=6 Hz, Si(CH₃)₂—CH₂—CH), 3.88 (s, N—CH₂—Si), 5.60 (m, 4H, CH═CH₂), 6.12 (m, 2H, —CH═CH₂), 7.83 (s, —C═CH—N—), 7.98 (d, ³J=9 Hz, Ar—H), 8.27, (d, ³J=9 Hz, NO₂—Ar—H). ¹³C-NMR (CDCl₃, δ_{C}, ppm): −0.89-1.17 (d, e, g, k) 17.05 (h, j) 22.50 (i), 41.95 (f), 121.66 (l) 124.32 (r), 125.91 (q), 137.20 (p), 145.30 (s), 147.17 (o), (a, b and c not visible).

### 1.f

Elastomer Film Synthesis with Functionalized Polymer (1.e):

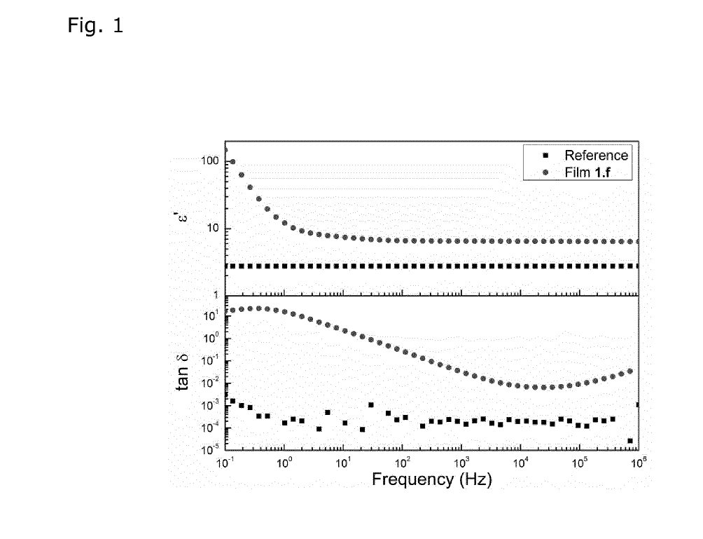

An elastomer was made according to the general elastomer synthesis procedure above with polymer 1.e. The dielectric properties of elastomer 1.f are shown in FIG. 1.

### Example 2

### 2.a

### 3-(3-chloropropyl)-1,1,3,5,5-pentamethyl-1,5-divinyltrisiloxane

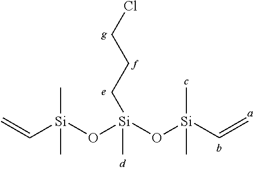 [SMILES: C=C[Si](C)(C)O[Si](C)(CCCCl)O[Si](C)(C)C=C]

3-Chloropropylmethyldimethoxysilane (6.7 g, 36.7 mmol) was dissolved in dry heptane (70 ml) in a 500 ml 2-necked round bottomed flask. Vinyldimethylsilane (7.7 g, 90.0 mmol) was added and the mixture was stirred for 5 min. Tris(pentafluorophenyl)borane (350 μl, 0.04 M) in dry toluene (2 ml) was added and methane gas was developed. The mixture was stirred at RT for 1 h where after neutral aluminum oxide (3 g) was added to remove the tris(pentafluorophenyl)borane catalyst. The reaction mixture was now filtered and solvent and excess reagent were removed in vacuo to give the product as a clear oil (11.5 g, 97%). IR (cm⁻¹): 2960 (C—H stretch); 1595 (Si—CH═CH₂ stretch); 1405 (Si—CH₂ stretch); 1255 (Si—CH₃ stretch); 1040 (Si—O stretch). ¹H NMR (CDCl₃, δ_{H}, ppm): 0.05-0.16 (m, 15H, CH₃—Si), 0.59 (m, 2H, —Si—CH₂—CH₂—), 1.79 (m, 2H, —CH₂—CH₂—CH₂—), 3.49 (t, 2H, ³J=6.9 Cl—CH₂—CH₂), 5.73 (dd, 2H, ²J=4.2, ³J=20, CH═CH₂), 5.94 (dd, 2H, ²J=2.7, ³J=14, CH═CH₂), 6.12 (dd, 2H, ³J=15, ³J=20, —CH═CH₂). ¹³C-NMR (CDCl₃, δ_{C}, ppm): −0.31 (d), −0.25 (c), 15.12 (e), 26.78 (f), 47.68 (g), 131.85 (a), 139.09 (b)

### 2.b

### 3-(3-azidopropyl)-1,1,3,5,5-pentamethyl-1,5-divinyltrisiloxane

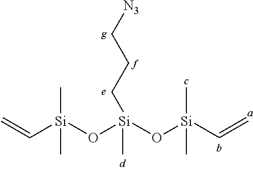 [SMILES: C=C[Si](C)(C)O[Si](C)(CCCN=[N+]=[N-])O[Si](C)(C)C=C]

2.a (5.0 g, 15.5 mmol) and NaN₃ (1.35 g, 20.6 mmol) were dissolved in DMF (70 ml) in a 250 ml 2-necked round bottomed flask. The reaction mixture was stirred at 60° C. for 15 hours. The reaction mixture was quenched with H₂O (70 ml) and extracted with heptane (5×70 ml). The organic phases were combined and washed with H₂O (3×70 ml) and brine (1×70 ml), dried with MgSO₄, filtered and concentrated in vacuo to give the product in the form of a light yellow oil (4.5 g, 88%). IR (cm⁻¹): 2960 (C—H stretch); 2095 (—N₃ stretch); 1595 (Si—CH═CH₂ stretch); 1405 (Si—CH₂ stretch); 1255 (Si—CH₃ stretch); 1040 (Si—O stretch). ¹H NMR (CDCl₃, δ_{H}, ppm): 0.05-0.16 (m, 15H, CH₃—Si), 0.59 (m, 2H, —Si—CH₂—CH₂—), 1.62 (m, 2H, —CH₂—CH₂—CH₂—), 3.22 (t, 2H, ³J=7.2 N₃—CH₂—CH₂), 5.73 (dd, 2H, ²J=4.2, ³J=20, CH═CH₂), 5.94 (dd, 2H, ²J=4.2, ³J=15 CH═CH₂), 6.12 (dd, 2H, ³J=15, ³J=20, —CH═CH₂). ¹³C-NMR (CDCl₃, δ_{C}, ppm): −0.33 (d), −0.24 (c), 14.58 (e), 22.79 (f), 54.08 (g), 131.86 (a), 139.09 (b).

### 2.c

### Chain Extension of 2.b to Form Chain Extended Polymer 2.c:

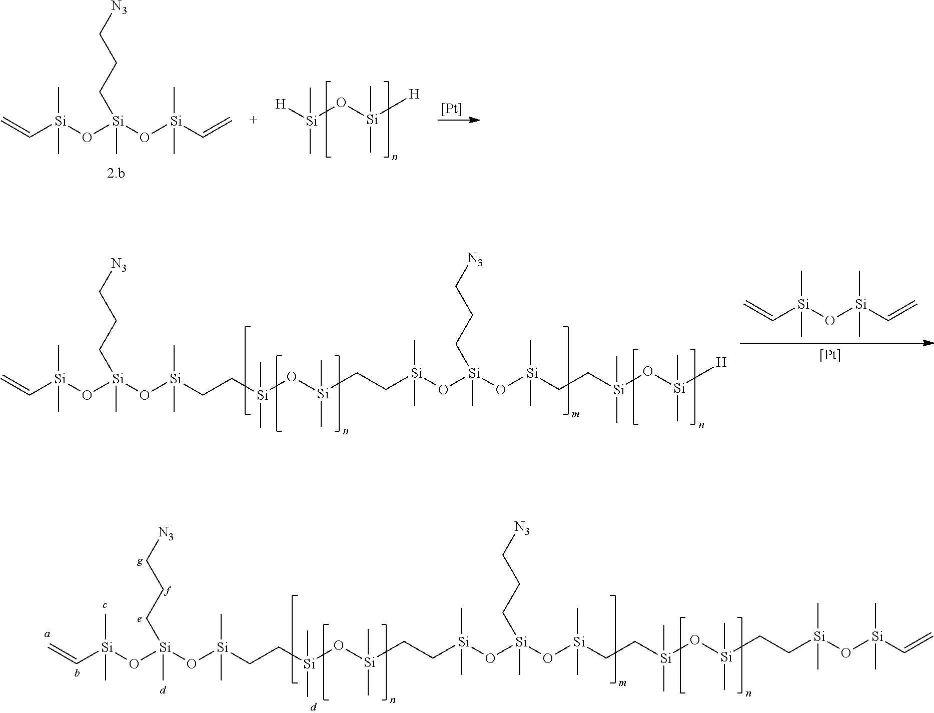

Hydride-terminated DMS (DMS H-11) was precipitated (ppt) in cold MeOH to remove inhibitor before using in the reactions. Dried DMS H-11 and azide-chain extender (2.b, 1.5 eq./mmol of DMS-H11, measured according to the weight of DMS H-11 after ppt in cold MeOH) were dissolved in dry toluene (5-7 ml/mmol of DMS H11) in a 2-necked round bottomed flask. The Karstedt's catalyst (platinum-divinyltetramethyl disiloxane complex in xylene) was diluted to 20% in dry toluene and weight of the catalyst was measured according to 1.5 mg of Pt/mmol of DMS-H11. The reaction mixture was stirred for 3 h at 50° C. followed by addition of the 1,3-divinyltetramethyldisiloxane for endcaping and stirring for 1 h at the same temperature (50° C.). Solvent was removed under vacuum and product was purified by ppt in dry MeOH followed by drying under vacuum. IR (cm-1): 2960 (C—H stretch); 2095 (—N3 stretch); 1630 (C═C stretch); 1410 (Si—CH2 stretch); 1260 (Si—CH3 stretch); 1010 (Si—O stretch). 1H NMR (CDCl3, δH, ppm): 0.05-0.16 (m, 15H, CH3-Si), 0.59 (m, 2H, —Si—CH2-CH2-), 1.62 (m, 2H, —CH2-CH2-CH2-), 3.22 (t, 3J=7.2 N3-CH2-CH2), 5.73 (dd, 2H, 2J=4.2, 3J=20, CH═CH2), 5.94 (dd, 2H, 2J=4.2, 3J=15 CH═CH2), 6.12 (dd, 2H, 3J=15, 3J=20, —CH═CH2). 13C-NMR (CDCl3, δC, ppm): −0.33 (d), −0.24 (c), 14.58 (e), 22.79 (f), 54.08 (g), 131.86 (a), 139.09 (b). SEC: M̅_{w}=16,500 g mol-1, M̅_{w}/M̅ₙ=3.99.

### 2.d

### Use of a Chain Extender in a Commercially Available Silicone Elastomer System in a One-Pot Process:

Chain extender 2.b, hydride-terminated dimethylsiloxane (DMS-H11, ˜1200 g mol⁻¹), cross-linker (VDT-431, 28,000 g mol⁻¹, 16-vinyl groups/chain), POWERSIL® XLR 630A/B and platinum catalyst (511, Hanse Chemie) were added to a plastic container and mixed either by hand or in a Speedmixer. The amounts can be seen in Table 1 for different wt % of the commercial system for films mixed by hand and in Table 2 for films mixed on speedmixer. The sample with 70 w % of commercial XLR 630A/B was mixed with solvent (Dow corning 05-20, 0.3 g). The mixtures were then poured into 1 mm thick steel molds and cured at 60° C. oven over night and afterwards in a 115° C. for 24 h.

TABLE 1
Amounts used for elastomer films 2.d for films mixed by hand.

| | 10 wt % | 30 wt % | 50 wt % | 70 wt % |
|---|---|---|---|---|
| Chain-extender | 0.053 | 0.4018 | 0.2877 | 0.1713 |
| 2.b [g] | | | | |
| DMS-H11 [g] | 1.9430 | 1.5231 | 1.0875 | 0.6488 |
| Cross-linker, | 0.2939 | 0.1931 | 0.1228 | 0.0701 |
| VDT-431 [g] | | | | |
| XLR 630A [g] | 0.1419 | 0.4765 | 0.7417 | 1.0677 |
| XLR 630B [g] | 0.2064 | 0.4659 | 0.7421 | 1.0700 |
| Catalyst [g] | 0.0320 | 0.0417 | 0.0510 | 0.0483 |

TABLE 2
Amounts used for elastomer films 2.d
for films mixed in speedmixer.

| | 10 wt % | 30 wt % | 50 wt % | 70 wt % |
|---|---|---|---|---|
| Chain-extender | 0.6083 | 0.4192 | 0.2754 | 0.3046 |
| 2.b [g] | | | | |
| DMS-H11 [g] | 1.9607 | 1.5237 | 1.0206 | 0.6502 |
| Cross-linker, | 0.2303 | 0.1750 | 0.1236 | 0.0809 |
| VDT-431 [g] | | | | |
| XLR 630A [g] | 0.1560 | 0.5113 | 0.7565 | 1.0505 |
| XLR 630B [g] | 0.1600 | 0.5032 | 0.8319 | 1.0736 |
| Catalyst [g] | 0.0313 | 0.0381 | 0.0402 | 0.0170 |

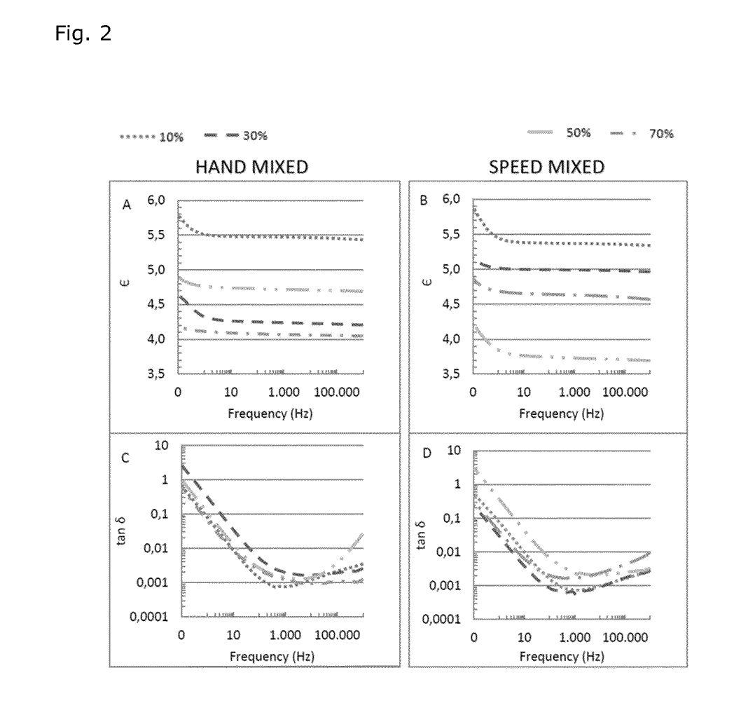

The dielectric properties of elastomer films 2.d are shown in FIG. 2.

### Example 3

### 3.a

### α,ω-methoxy-poly((chloropropyl)methylsiloxane-co-dimethylsiloxane) with ˜1200 g mol⁻¹ prepolymer

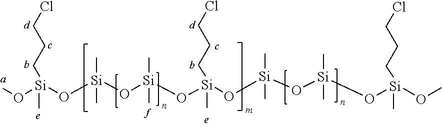

3-Chloropropylmethyldimethoxysilane (7.23 g, 39.6 mmol) was dissolved in dry heptane (220 mL) in a 2000 mL 2-neck round bottom flask. Hydride-terminated dimethylsiloxane (˜1200 g mol⁻¹) (50 g, 41.7 mmol) was added and the mixture was stirred for 5 min. Tris(pentafluorophenyl)borane (2 mL, 0.04 M, 0.2 mol %) in dry toluene was added and methane gas developed. The mixture was stirred at RT for 1 h where after dimethoxydimethylsilane (19.4 g, 163 mmol) was added in excess in order to quench any potential remaining hydride-groups and ensure that all polymers possessed methoxy end-groups. The reaction mixture was stirred additionally for a couple of hours. The solvent and excess dimethoxydimethylsilane (bp: 82° C.) were removed in vacuo at 45° C. with toluene to give the product as a clear oil (55.6 g, 99.8%). IR (cm⁻¹): 2960 (C—H stretch); 1410 (Si—CH₂ stretch); 1260 (Si—CH₃ stretch); 1010 (Si—O stretch). ¹H NMR (CDCl₃, δ_{H}, ppm): 0.08-0.09 (m, CH₃—Si), 0.63 (m, —Si—CH₂—CH₂—), 1.83 (m, —CH₂—CH₂—CH₂), 3.49 (s, 6H, —O—CH₃), 3.50 (t, ³J=6.9, Cl—CH₂—CH2). ¹³C-NMR (CDCl₃, δC, ppm): −0.51-1.54 (e+f), 15.06 (b), 26.78 (c), 47.59 (d), 49.90 (a). SEC (toluene): M̅_{w}=23,000 g mol⁻¹.

### 3.b α,ω-allyl-poly((chloropropyl)methylsiloxane-co-dimethylsiloxane) with ˜1200 g mol⁻¹ prepolymer

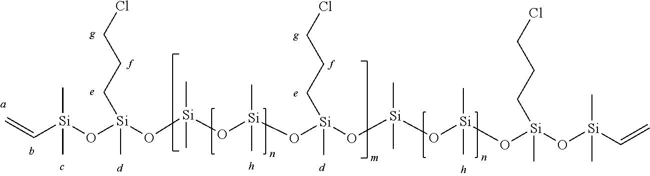

Copolymer 3.a (56 g, 4.8 mmol methoxy end-groups) was dissolved in dry heptane (150 mL) in a 500 mL 2-neck round bottom flask. Allyldimethylsilane (9.76 g, 97.4 mmol) was added and the mixture was stirred at RT overnight after which ¹H-NMR was used in order to confirm the removal of methoxy groups and conversion to allyl groups. Neutral aluminum oxide (15 g) was added to the reaction mixture to remove the tris(pentafluorophenyl)borane catalyst and the solution was filtered through 0.45 μm PFTE filters. The solvent and excess allyldimethylsilane reagent were removed in vacuo to give the product as a clear oil (54.9 g, 98.0%). IR (cm⁻¹): 2960 (C—H stretch); 1630 (C═C stretch); 1410 (Si—CH₂ stretch); 1260 (Si—CH₃ stretch); 1010 (Si—O stretch). ¹H NMR (CDCl₃, δ_{H}, ppm): −0.05-0.09 (m, CH₃—Si), 0.62 (m, —Si—CH₂—CH₂—), 1.50 (d, 4H, ³J=8.1, CH₂—CH═CH₂), 1.82 (m, —CH₂—CH₂—CH₂—), 3.50 (t, ³J=6.9, Cl—CH₂—CH₂), 4.83 (m, 4H, CH═CH₂), 5.77 (m, 2H, CH═CH₂). ¹³C-NMR (CDCl₃, c, ppm): −0.53-1.54 (d+e+i), 15.04 (f), 23.41 (c), 26.75 (g), 47.61 (h), 112.53 (a), 135.30 (b). SEC (toluene): M̅_{w}=23,000 g mol⁻¹.

### 3.c

### α,ω-allyl-poly((azidopropyl)methylsiloxane-co-dimethylsiloxane) with ˜1200 g mol-1 prepolymer

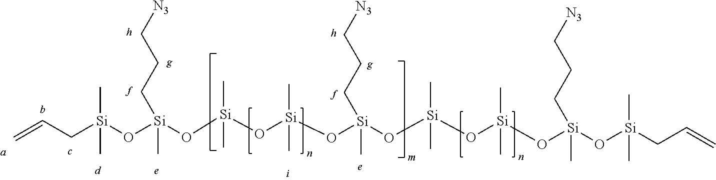

Following a procedure adapted from Rambarran et al, Generic, Metal-Free Cross-Linking and Modification of Silicone Elastomers Using Click Ligation, Macromolecules, 2012, 45, 2276-2285 copolymer 3.b (51.7 g, ˜38.2 mmol (chloropropyl)methylsiloxane units), NaN3 (12.4 g, 191 mmol) and tetrabutylammonium azide (1.09 g, 3.82 mmol) were dissolved in dry THF (250 mL) in a 500 mL round bottom flask. The reaction mixture was stirred under reflux 48 hours. THF was removed in vacuo and the reaction mixture was re-dissolved in heptane (250 mL), washed with water (3×200 mL) and brine (1×200 mL), dried with MgSO4, filtered and concentrated in vacuo to afford a transparent viscous liquid (50.0 g, 96.6%). IR (cm⁻¹): 2960 (C—H stretch); 2095 (—N₃ stretch); 1630 (C═C stretch); 1410 (Si—CH₂ stretch); 1260 (Si—CH3 stretch); 1010 (Si—O stretch). ¹H NMR (CDCl₃, δ_{H}, ppm): −0.05-0.09 (m, CH₃—Si), 0.58 (m, —Si—CH₂—CH₂—), 1.50 (d, 4H, ³J=8.1, CH₂—CH═CH₂), 1.65 (m, —CH₂—CH₂—CH₂—), 3.23 (t, ³J=7.1, N₃—CH₂—CH₂), 4.83 (m, 4H, CH═CH₂), 5.77 (m, 2H, CH═CH₂). ¹³C-NMR (CDCl₃, ac, ppm): −0.55-1.03 (d+e+i), 14.50 (f), 22.77 (g), 23.40 (c), 54.14 (h), 112.51 (a), 135.32 (b). SEC (toluene): M̅_{w}=23,000 g mol⁻¹.

### 3.d

### Synthesis of functionalized polymer α,ω-allyl-poly((4-(4-nitrophenyl)-1H-1,2,3-triazolepropyl)methylsiloxane-co-dimethylsiloxane) with ˜1200 g mol-1 prepolymer

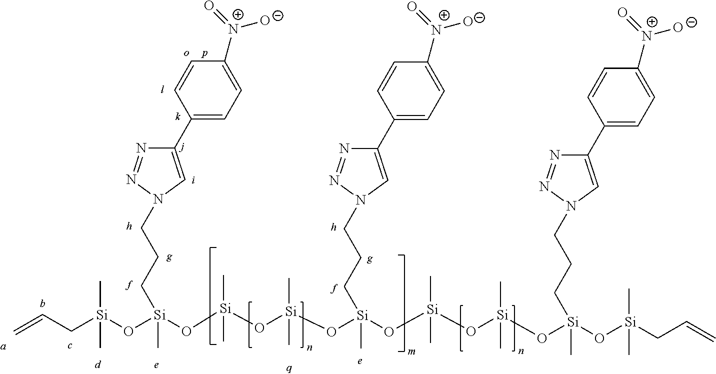

3.c (20 g, ˜15.3 mmol (azidopropyl)methylsiloxane units) and 1-ethynyl-4-nitrobenzene (4.52 g, 30.7 mmol) were dissolved in dry THF (100 mL) in a 250 mL 2-neck round bottom flask. CuI (0.29 g, 1.50 mmol) was subsequently added and Et₃N (2.33 g, 23.0 mmol) was added drop wise. The reaction was carried out at 40° C. for 17 hours at which point FTIR confirmed the disappearance of the azide band at 2095 cm⁻¹. THF was evaporated and the reaction mixture was precipitated into cold methanol. The solvent was decanted and the product was dried in vacuo giving a dark green viscous oil in quantitative yield). IR (cm⁻¹): 2960 (C—H stretch); 1605 (aromatic C═C stretch); 1520 (N═O asymmetric stretch); 1410 (Si—CH₂ stretch); 1340 (N═O symmetric stretch); 1260 (Si—CH₃ stretch); 1010 (Si—O stretch). ¹H NMR (CDCl₃, δ_{H}, ppm): −0.45-0.13 (m, CH₃—Si), 0.55 (m, —Si—CH₂—CH₂—), 1.57 (d, 4H, ³J=8.1, CH₂—CH═CH₂), 2.02 (m, —CH₂—CH₂—CH₂—), 4.41 (t, ³J=7.2, N—CH₂—CH₂), 4.83 (m, 4H, CH═CH₂), 5.77 (m, 2H, CH═CH₂), 7.90 (s, —C═CH—N), 7.99 (m, Ar—H), 8.27 (m, NO₂—Ar—H). ¹³C-NMR (CDCl₃, δ_{C}, ppm): −0.55-1.03 (d+e+q), 14.23 (f), 24.39 (g), 53.09 (h), 120.68 (i), 124.29 (o), 126.05 (l), 145.45 (p), 147.26 (j) (a, b and c not visible).

### 3.e

Elastomer Film Synthesis with Chain-Extended Polymer (3.b):

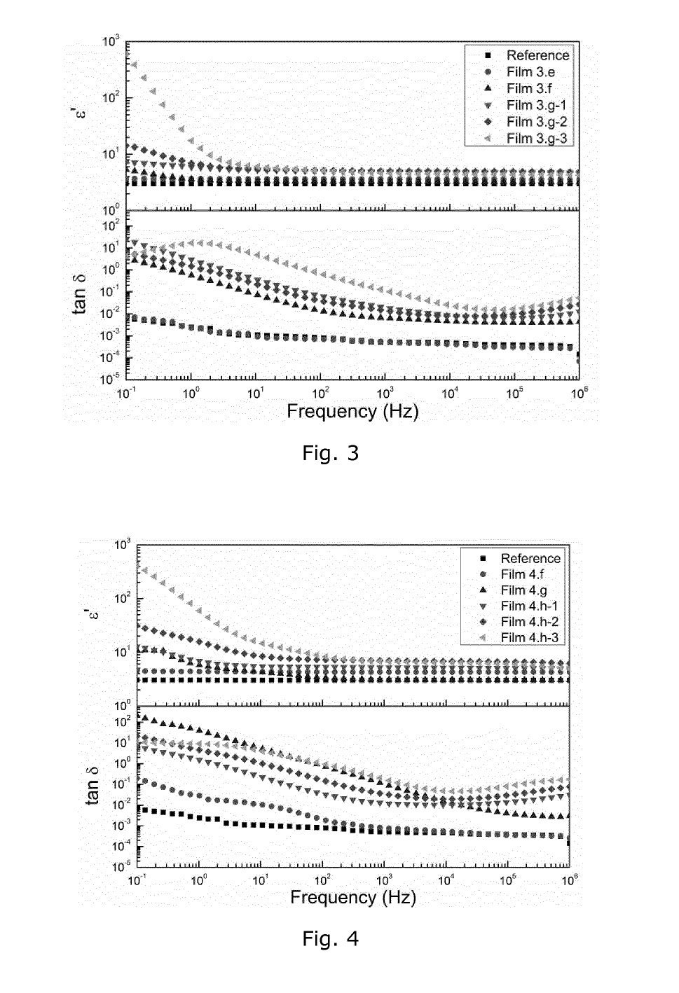

The elastomer was made according to the general elastomer synthesis procedure with polymer 3.b. The dielectric properties of elastomer 3.e are shown in FIG. 3.

### 3.f

Elastomer Film Synthesis with Chain-Extended Polymer (3.c):

The elastomer was made according to the general elastomer synthesis procedure with polymer 3.c. The dielectric properties of elastomer 3.f are shown in FIG. 3.

### 3.g

Elastomer Film Synthesis with Functionalized Polymer (3.d):

The elastomer was made according to the general elastomer synthesis procedure with polymer 3.d. The dielectric properties of elastomer 3.g are shown in FIG. 3.

### Example 4

### 4.a

### α,ω-methoxy-poly((chloropropyl)methylsiloxane-co-dimethylsiloxane) with ˜580 g mol⁻¹ prepolymer

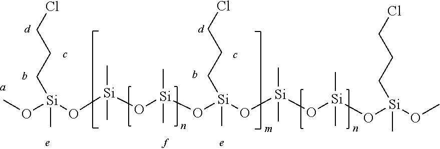

3-Chloropropylmethyldimethoxysilane (15 g, 82.1 mmol) was dissolved in dry heptane (150 mL) in a 2000 mL 2-neck round bottom flask. Hydride-terminated dimethylsiloxane (˜580 g mol⁻¹) (45.7 g, 78.8 mmol) was added and the mixture was stirred for 5 min. Tris(pentafluorophenyl)borane 4.2 mL, 0.04 M, 0.2 mol %) in dry toluene was added and methane gas developed. The mixture was stirred at RT for 1 h where after dimethoxydimethylsilane (39.6 g, 329.4 mmol) was added in excess in order to quench any potential remaining hydride-groups and ensure that all polymers possessed methoxy end-groups. The reaction mixture was stirred additionally for a couple of hours. The solvent and excess dimethoxydimethylsilane (bp: 82° C.) were removed in vacuo at 45° C. with toluene to give the product as a clear oil (57.9 g, 99.3%). IR (cm⁻¹): 2960 (C—H stretch); 1410 (Si—CH₂ stretch); 1260 (Si—CH₃ stretch); 1010 (Si—O stretch). ¹H NMR (CDCl₃, δ_{H}, ppm): 0.08-0.09 (m, CH₃—Si), 0.63 (m, —Si—CH₂—CH₂—), 1.83 (m, —CH₂—CH₂—CH₂), 3.49 (s, 6H, —O—CH₃), 3.50 (t, ³J=6.9, Cl—CH₂—CH2). ¹³C-NMR (CDCl₃, (c, ppm): −0.51-1.54 (e+f), 15.06 (b), 26.78 (c), 47.59 (d), 49.90 (a). SEC (toluene): M̅_{w}=23,000 g mol⁻¹.

### 4.b

### α,ω-allyl-poly((chloropropyl)methylsiloxane-co-dimethylsiloxane) with ˜580 g mol⁻¹ prepolymer

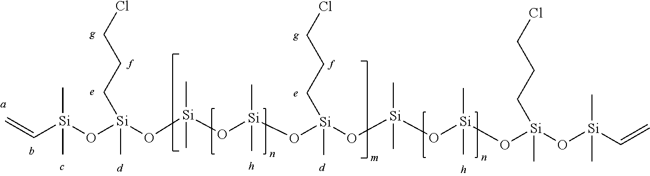

Copolymer 4.a (57.5 g, 5.0 mmol methoxy end-groups) was dissolved in dry heptane (150 mL) in a 500 mL 2-neck round bottom flask. Allyldimethylsilane (10.0 g, 100 mmol) was added and the mixture was stirred at RT overnight after which ¹H-NMR was used in order to confirm the removal of methoxy groups and conversion to allyl groups. Neutral aluminum oxide (15 g) was added to the reaction mixture to remove the tris(pentafluorophenyl)borane catalyst and the solution was filtered through 0.45 μm PFTE filters. The solvent and excess allyldimethylsilane reagent were removed in vacuo to give the product as a clear oil (56.5 g, 98.3%). IR (cm⁻¹): 2960 (C—H stretch); 1630 (C═C stretch); 1410 (Si—CH₂ stretch); 1260 (Si—CH₃ stretch); 1010 (Si—O stretch). ¹H NMR (CDCl₃, δ_{H}, ppm): −0.05-0.09 (m, CH₃—Si), 0.62 (m, —Si—CH₂—CH₂—), 1.50 (d, 4H, ³J=8.1, CH₂—CH═CH₂), 1.82 (m, —CH₂—CH₂—CH₂—), 3.50 (t, ³J=6.9, Cl—CH₂—CH₂), 4.83 (m, 4H, CH═CH₂), 5.77 (m, 2H, CH═CH₂). ¹³C-NMR (CDCl₃, δC, ppm): −0.53-1.54 (d+e+i), 15.04 (f), 23.41 (c), 26.75 (g), 47.61 (h), 112.53 (a), 135.30 (b). SEC (toluene): M̅_{w}=23,000 g mol⁻¹.

### 4.c

### α,ω-allyl-poly((azidopropyl)methylsiloxane-co-dimethylsiloxane) with ˜580 g mol-1 prepolymer

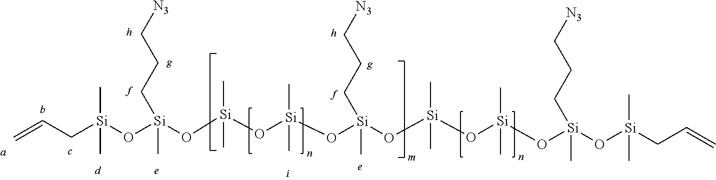

Following a procedure adapted from Rambarran et al, Generic, Metal-Free Cross-Linking and Modification of Silicone Elastomers Using Click Ligation, Macromolecules, 2012, 45, 2276-2285 copolymer 4.b (56 g, ˜76.4 mmol (chloropropyl)methylsiloxane units), NaN₃ (19.9 g, 306 mmol) and tetrabutylammonium azide (2.17 g, 7.64 mmol) were dissolved in dry THF (300 mL) in a 500 mL round bottom flask. The reaction mixture was stirred under reflux 48 hours. THF was removed in vacuo and the reaction mixture was re-dissolved in heptane (300 mL), washed with water (3×230 mL) and brine (1×230 mL), dried with MgSO₄, filtered and concentrated in vacuo to afford a transparent viscous liquid (51.0 g, 91.1%). IR (cm⁻¹): 2960 (C—H stretch); 2095 (—N₃ stretch); 1630 (C═C stretch); 1410 (Si—CH₂ stretch); 1260 (Si—CH₃ stretch); 1010 (Si—O stretch). ¹H NMR (CDCl₃, δ_{H}, ppm): −0.05-0.09 (m, CH₃—Si), 0.58 (m, —Si—CH₂—CH2-), 1.50 (d, 4H, ³J=8.1, CH₂—CH═CH₂), 1.65 (m, —CH₂—CH₂—CH₂—), 3.23 (t, ³J=7.1, N₃—CH₂—CH₂), 4.83 (m, 4H, CH═CH₂), 5.77 (m, 2H, CH═CH2). ¹³C-NMR (CDCl₃, δ_{C}, ppm): −0.55-1.03 (d+e+i), 14.50 (f), 22.77 (g), 23.40 (c), 54.14 (h), 112.51 (a), 135.32 (b). SEC (toluene): M̅_{w}=23,000 g mol⁻¹.

### 4.d

### Synthesis of functionalized polymer α,ω-allyl-poly((4-(4-nitrophenyl)-1H-1,2,3-triazolepropyl)methylsiloxane-co-dimethylsiloxane) with ˜580 g mol-1 prepolymer

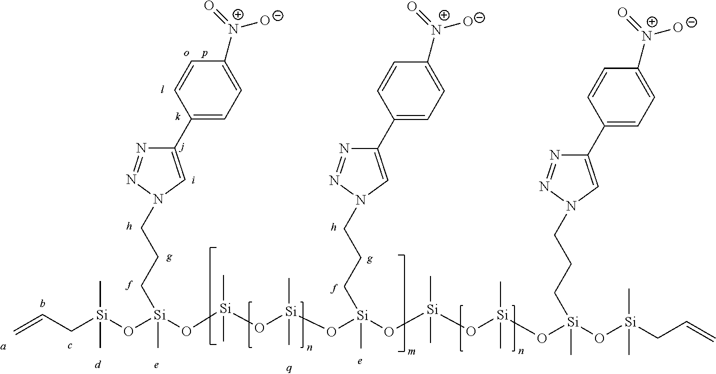

4.c (10 g, ˜13.6 mmol (azidopropyl)methylsiloxane units) and 1-ethynyl-4-nitrobenzene (4.02 g, 27.3 mmol) were dissolved in dry THF (50 mL) in a 100 mL 2-neck round bottom flask. CuI (0.26 g, 1.37 mmol) was subsequently added and Et₃N (2.07 g, 20.5 mmol) was added drop wise. The reaction was carried out at 40° C. for 17 hours at which point FTIR confirmed the disappearance of the azide band at 2095 cm-1. THF was evaporated and the reaction mixture was precipitated into cold methanol. The solvent was decanted and the product was dried in vacuo giving a dark green viscous oil in quantitative yield). IR (cm⁻¹): 2960 (C—H stretch); 1605 (aromatic C═C stretch); 1520 (N═O asymmetric stretch); 1410 (Si—CH2 stretch); 1340 (N═O symmetric stretch); 1260 (Si—CH₃ stretch); 1010 (Si—O stretch). ¹H NMR (CDCl₃, δ_{H}, ppm): −0.45-0.13 (m, CH₃—Si), 0.55 (m, —Si—CH₂—CH₂—), 1.57 (d, 4H, ³J=8.1, CH₂—CH═CH₂), 2.02 (m, —CH₂—CH₂—CH₂—), 4.41 (t, ³J=7.2, N—CH₂—CH₂), 4.83 (m, 4H, CH═CH₂), 5.77 (m, 2H, CH═CH₂), 7.90 (s, —C═CH—N), 7.99 (m, Ar—H), 8.27 (m, NO2-Ar—H). ¹³C-NMR (CDCl₃, δ_{C}, ppm): −0.55-1.03 (d+e+q), 14.23 (f), 24.39 (g), 53.09 (h), 120.68 (i), 124.29 (o), 126.05 (l), 145.45 (p), 147.26 (j) (a, b and c not visible).

### 4.e

### Synthesis of functionalized polymer α,ω-vinyl-poly((1-ethyl-1H-imidazol-3-ium chloride)-1H-1,2,3-triazolepropyl)methylsiloxane-co-dimethylsiloxane)

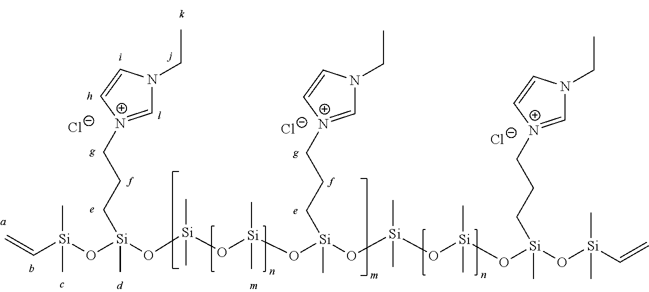

4.b (14.0 g, ˜19.1 mmol (chloropropyl)methylsiloxane units) and 1-ethylimidazole (9.19 g, 95.6 mmol) were mixed in a 250 mL 2-neck round bottom flask. The reaction was carried out at 95° C. for 48 hours under reflux. The product was washed 4 times with toluene to remove excess 1-ethylimidazole and dried in vacuo to give the product as an orange-brown oil (7.3 g, 46.0%). IR (cm⁻¹): 3085 (C═C stretch); 2965 (C—H stretch); 1630 (C═N, C═C stretch); 1565 (C═N ring stretch); 1455 (C—H bend); 1405 (Si—CH₂ stretch); 1260 (Si—CH₃ stretch); 1010 (Si—O stretch). ¹H NMR (CDCl₃, δ_{H}, ppm): 0.073-0.16 (m, CH₃—Si), 0.54 (m, —Si—CH₂—CH₂—), 1.60 (m, CH₃—CH₂—N—), 1.94 (m, —CH₂—CH₂—CH₂—), 4.35 (m, CH₃—CH₂—N—), 4.43 (m, —N⁺—CH₂—CH₂—CH₂—), 5.73 (dd, 2H, ²J=4.2 Hz, ³J=20 Hz, CH═CH₂), 5.94 (dd, 2H, ²1=4.1 Hz, ³J=15 Hz, CH═CH₂), 6.13 (dd, 2H, ³J=15 Hz, ³J=20 Hz, —CH═CH₂), 7.42 (d, ³J=1.5 Hz, N⁺—CH═CH—), 7.60 (d, ³J=1.5 Hz, N⁺—CH═CH—), 10.9 (s, —N—CH═N⁺—). ¹³C-NMR (CDCl₃, δ_{C}, ppm): −0.66-1.09 (c+d+m), 13.60 (e), 15.53 (k), 24.24 (f), 45.10 (j), 52.07 (g), 121.34 (i), 122.15 (h), 136.54 (l), (a and b not visible).

### 4.f

Elastomer Film Synthesis with Chain-Extended Polymer (4.b):

The elastomer was made according to the general elastomer synthesis procedure with polymer 4.b. The dielectric properties of elastomer 4.f are shown in FIG. 4.

### 4.g

Elastomer Film Synthesis with Chain-Extended Polymer (4.c):

The elastomer was made according to the general elastomer synthesis procedure with polymer 4.c. The dielectric properties of elastomer 4.g are shown in FIG. 4.

### 4.h

Elastomer Film Synthesis with Functionalized Polymer (4.d):

The elastomer was made according to the general elastomer synthesis procedure with polymer 4.d. The dielectric properties of elastomer 4.h are shown in FIG. 4.

### 4.i

Elastomer Film Synthesis with Functionalized Polymer (4.e):

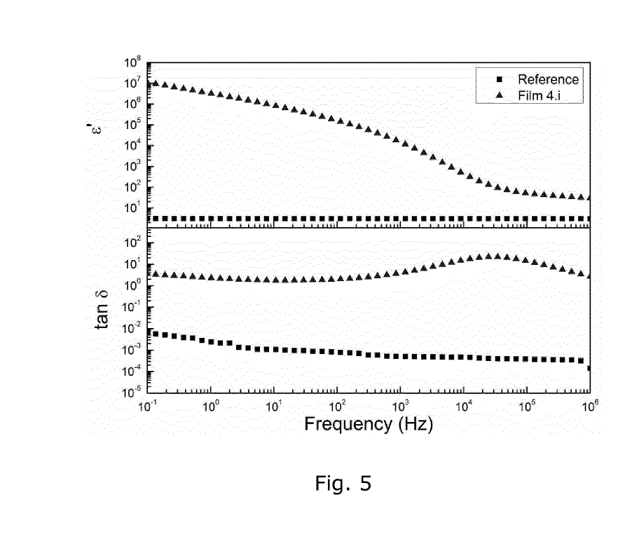

The elastomer was made according to the general elastomer synthesis procedure with polymer 4.e. The dielectric properties of elastomer 4.i are shown in FIG. 5.

### LIST OF REFERENCES

Bahrt Madsen et al., Novel cross-linkers for PDMS networks for controlled and well distributed grafting of functionalities by click chemistry, Polym. Chem., 2013, 4, 1700-1707
Gonzaga et al., Morphology-Controlled Synthesis of Poly(oxyethylene)silicone or Alkylsilicone Surfactants with Explicit, Atomically Defined, Branched, Hydrophobic Tails, Chem. Eur. J. 2012, 18, 1536-1541
Zhang et al, Modular Synthesis of Polyferrocenylsilane Block Copolymers by Cu-Catalyzed Alkyne/Azide “Click” Reactions, Macromolecules 2013, 46, 1296-1304
Rambarran et al, Generic, Metal-Free Cross-Linking and Modification of Silicone Elastomers Using Click Ligation, Macromolecules, 2012, 45, 2276-2285
U.S. Pat. No. 8,097,639 B2
U.S. Pat. No. 8,022,157 B2
WO 2009/141738 A2

1. A compound of formula I: 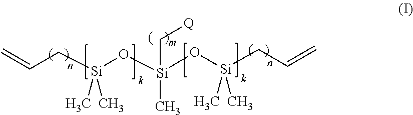
wherein Q is selected from the group consisting of —C≡CH, —N₃, —CN, halogen, —OH, —SH, —NH₂, —NO₂, —NCO, alkyl, alkenyl, alkynyl, cycloalkyl, cycloalkenyl, heterocycloalkyl, aryl, heteroaryl, aminoalkyl, alkoxy, —COOR, —O—C(═O)—R, —NH—C(═O)—R, —C(═O)—NH—R, —NH—C(═O)—O—R, —SO₃R, —O—(O═)₂S—R, and —P(═O)(OR)₂, wherein R is selected from the group consisting of H, alkyl, alkenyl, alkynyl, cycloalkyl, cycloalkenyl, heterocycloalkyl, aryl, and heteroaryl; wherein said alkyl, alkenyl, alkynyl, cycloalkyl, cycloalkenyl, heterocycloalkyl, aryl, heteroaryl, aminoalkyl, alkoxy, —COOR, —O—C(═O)—R, —NH—C(═O)—R, —C(═O)—NH—R, —NH—C(═O)—O—R, —SO₃R, —O—(O═)₂S—R, and —P(═O)(OR)₂ may be substituted by one or more substituents independently selected from the group consisting of —N₃, —CN, —Cl, —Br, —I, —OH, —SH, —NH₂, —NO₂, —NCO, C₁₋₆-alkyl, C₂₋₆-alkenyl and C₂₋₆-alkynyl;
k is an integer selected from the range of 1-3;
m is an integer selected from the range of 1-6; and
n is an integer independently selected from the range of 0-6.

2. The compound according to claim 1, wherein Q is selected from the group consisting of —C≡CH, —N₃, —F, —Cl, —Br, —I, —OH, C₁₋₆-alkyl, C₁₋₆-aminoalkyl, C₂₋₆-alkenyl, C₂₋₆-alkynyl, phenyl, naphthyl, imidazolyl, tetrazolyl, triazolyl, —O—C(═O)—R, and —NH—C(═O)—R, wherein R is C₁₋₆-alkyl or phenyl, wherein said C₁₋₆-alkyl, C₁₋₆-aminoalkyl, C₂₋₆-alkenyl, C₂₋₆-alkynyl, phenyl, naphthyl, imidazolyl, tetrazolyl, triazolyl, —O—C(═O)—R, and —NH—C(═O)—R is optionally substituted by one or more substituents independently selected from the group consisting of —N₃, —CN, —Cl, —Br, —OH, —SH, —NH₂, —NO₂, —NCO, C₁₋₆-alkyl, C₂₋₆-alkenyl, and C₂₋₆-alkynyl, preferably wherein Q is —Cl or —N₃.

3. The compound according to claim 1 wherein each k is 1 or 2.

4. The compound according to claim 1, wherein m is an integer selected from the range of 1-4.

5. The compound according to claim 1, wherein each n is 0 or 1.

6. A chain extended silicone polymer or copolymer of the formula II comprising:
CEₚ-[SP-CE]ₒ-SP₍₁₋ₚ₎ (II)
wherein CE is a chain extender moiety of the formula (III) 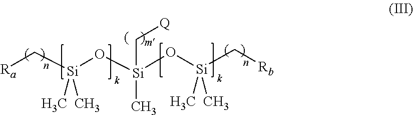
wherein Q is selected from the group consisting of —C≡CH, —N₃, —CN, halogen, —OH, —SH, —NH₂, —NO₂, —NCO, alkyl, alkenyl, alkynyl, cycloalkyl, cycloalkenyl, heterocycloalkyl, aryl, heteroaryl, aminoalkyl, alkoxy, —COOR, —O—C(═O)—R, —NH—C(═O)—R, —C(═O)—NH—R, —NH—C(═O)—O—R, —SO₃R, —O—(O═)₂S—R, and —P(═O)(OR)₂, wherein R is selected from the group consisting of H, alkyl, alkenyl, alkynyl, cycloalkyl, cycloalkenyl, heterocycloalkyl, aryl, and heteroaryl; wherein said alkyl, alkenyl, alkynyl, cycloalkyl, cycloalkenyl, heterocycloalkyl, aryl, heteroaryl, aminoalkyl, alkoxy, —COOR, —O—C(═O)—R, —NH—C(═O)—R, —C(═O)—NH—R, —NH—C(═O)—O—R, —SO₃R, —O—(O═)₂S—R, and —P(═O)(OR)₂ may be substituted by one or more substituents independently selected from the group consisting of —N₃, —CN, halogen, —OH, —SH, —NH₂, —NO₂, —NCO, C₁₋₆-alkyl, C₂₋₆-alkenyl and C₂₋₆-alkynyl;
Rₐ and R_{b} are the same and are selected from the group consisting of H, C₁₋₆ alkyl, C₁₋₆ alkoxy, and C₂₋₆ alkenyl;
k is an integer selected from the range of 1-3;
m′ is an integer selected from the range of 0-6; and
n is an integer independently selected from the range of 0-6;
SP is a silicone polymer or copolymer of the formula IV 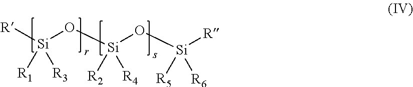
wherein each R₁, R₂, R₃, R₄, R₅ and R₆ is independently selected from the group consisting of —CN, halogen, —OH, —SH, —NH₂, —NO₂, —NCO, alkyl, alkenyl, alkynyl, cycloalkyl, cycloalkenyl, heterocycloalkyl, aryl, heteroaryl, aminoalkyl, alkoxy, —COOR, —O—C(═O)—R, —NH—C(═O)—R, —C(═O)—NH—R, —NH—C(═O)—O—R, —SO₃R, —O—(O═)₂S—R, and —P(═O)(OR)₂, wherein R is selected from the group consisting of H, alkyl, alkenyl, alkynyl, cycloalkyl, cycloalkenyl, heterocycloalkyl, aryl, and heteroaryl; wherein said alkyl, alkenyl, alkynyl, cycloalkyl, cycloalkenyl, heterocycloalkyl, aryl, heteroaryl, aminoalkyl, alkoxy, —COOR, —O—C(═O)—R, —NH—C(═O)—R, —C(═O)—NH—R, —NH—C(═O)—O—R, —SO₃R, —O—(O═)₂S—R, and —P(═O)(OR)₂ may be substituted by one or more substituents independently selected from the group consisting of —CN, —F, —Cl, —Br, I, —OH, —SH, —NH₂, —NO₂, —NCO, C₁₋₆-alkyl, C₂₋₆-alkenyl, and C₂₋₆-alkynyl;
r and s are integers selected from the range of 0-2500, wherein the sum of (r+s) is in the range of 1-2500;
o is an integer selected from the range of 0-1000, and
p is selected from the group consisting of 0 and 1; and
R′ and R″ are absent or are selected from the group consisting of H, C₁₋₆alkyl, and C₂₋₆ alkenyl.

7. The chain extended silicone polymer or copolymer according to claim 6, wherein each R₁, R₂, R₃, and R₄ are selected from the group consisting of C₁₋₆ alkyl and phenyl.

8. The chain extended silicone polymer or copolymer according claim 6, wherein r and s are each independently selected from the range of 0-100.

9. The chain extended silicone polymer or copolymer according claim 6, wherein o is an integer selected from the range of 5-500.

10. A functionalized, chain extended silicone polymer or copolymer of the formula (V)
CE(L-Y)ₚ-[SP-CE(L-Y)]ₒ-SP₍₁₋ₚ₎ (V)
wherein CE(L-Y) is a compound of the formula (VI) 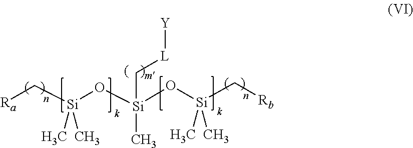
wherein Rₐ and R_{b} are the same and are selected from the group consisting of H, C₁₋₆ alkyl, C₁₋₆ alkoxy, and C₂₋₆ alkenyl;
k is an integer selected from the range of 1-3;
m′ is an integer selected from the range of 0-6;
n is an integer independently selected from the range of 0-6;
L is a linker; and
Y is a functional group;
SP is a silicone polymer or copolymer of the formula (IV) 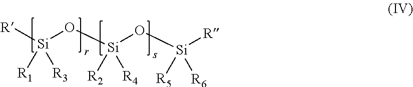
as defined in claim 6,
o is an integer selected from the range of 0-1000, and p is selected from the group consisting of 0 and 1.

11. The functionalized, chain extended silicone polymer or copolymer according to claim 10, wherein L is selected from the group consisting of a direct bond, heterocycloalkyl and heteroaryl.

12. The functionalized, chain extended silicone polymer or copolymer according to claim 10, wherein Y is a functional group selected from the group consisting of a biomedical group, a group providing electroactivity, and a surface-modifying group.

13. A method of preparing a chain-extended silicone polymer or copolymer of the formula II
CE_{P}-[SP-CE]ₒ-SP₍₁₋ₚ₎ (II)
comprising the step of reacting a compound CE of the formula III 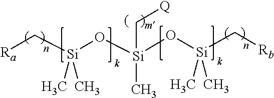
wherein Rₐ and R_{b} are the same and are selected from the group consisting of H, C₁₋₆ alkyl, C₁₋₆ alkoxy, and C₂₋₆ alkenyl;
Q is selected from the group consisting of —C═CH, —N₃, —CN, halogen, —OH, —SH, —NH₂, —NO₂, —NCO, alkyl, alkenyl, alkynyl, cycloalkyl, cycloalkenyl, heterocycloalkyl, aryl, heteroaryl, aminoalkyl, alkoxy, —COOR, —O—C(═O)—R, —NH—C(═O)—R, —C(═O)—NH—R, —NH—C(═O)—O—R, —SO₃R, —O—(O═)₂S—R, and —P(═O)(OR)₂, wherein R is selected from the group consisting of H, alkyl, alkenyl, alkynyl, cycloalkyl, cycloalkenyl, heterocycloalkyl, aryl, and heteroaryl; wherein said alkyl, alkenyl, alkynyl, cycloalkyl, cycloalkenyl, heterocycloalkyl, aryl, heteroaryl, aminoalkyl, alkoxy, —COOR, —O—C(═O)—R, —NH—C(═O)—R, —C(═O)—NH—R, —NH—C(═O)—O—R, —SO₃R, —O—(O═)₂S—R, and —P(═O)(OR)₂ may be substituted by one or more substituents independently selected from the group consisting of —N₃, —CN, halogen, —OH, —SH, —NH₂, —NO₂, —NCO, C₁₋₆-alkyl, C₂₋₆-alkenyl and C₂₋₆-alkynyl;
k is an integer selected from the range of 1-3;
m′ is an integer selected from the range of 0-6; and
n is an integer independently selected from the range of 0-6;
with a silicone polymer or copolymer SP of the formula IV 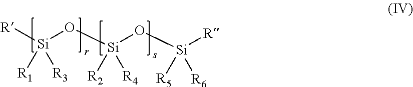
wherein each R₁, R₂, R₃, R₄, R₅ and R₆ is independently selected from the group consisting of —CN, halogen, —OH, —SH, —NH₂, —NO₂, —NCO, alkyl, alkenyl, alkynyl, cycloalkyl, cycloalkenyl, heterocycloalkyl, aryl, heteroaryl, aminoalkyl, alkoxy, —COOR, —O—C(═O)—R, —NH—C(═O)—R, —C(═O)—NH—R, —NH—C(═O)—O—R, —SO₃R, —O—(O═)₂S—R, and —P(═O)(OR)₂, wherein R is selected from the group consisting of H, alkyl, alkenyl, alkynyl, cycloalkyl, cycloalkenyl, heterocycloalkyl, aryl, and heteroaryl; wherein said alkyl, alkenyl, alkynyl, cycloalkyl, cycloalkenyl, heterocycloalkyl, aryl, heteroaryl, aminoalkyl, alkoxy, —COOR, —O—C(═O)—R, —NH—C(═O)—R, —C(═O)—NH—R, —NH—C(═O)—O—R, —SO₃R, —O—(O═)₂S—R, and —P(═O)(OR)₂ may be substituted by one or more substituents independently selected from the group consisting of —CN, —F, —Cl, —Br, I, —OH, —SH, —NH₂, —NO₂, —NCO, C₁₋₆-alkyl, C₂₋₆-alkenyl, and C₂₋₆-alkynyl;
r and s are integers selected from the range of 0-2500, wherein the sum of (r+s) is in the range of 1-2500;
o is an integer selected from the range of 0-1000, and
p is selected from the group consisting of 0 and 1; and
R′ and R″ are absent or are selected from the group consisting of H, C₁₋₆alkyl, and C₂₋₆alkenyl.

14. A method of preparing a functionalized, chain extended silicone polymer or copolymer of the formula V:
CE(L-Y)ₚ-[SP-CE(L-Y)]ₒ-SP₍₁₋ₚ₎ (V)
as defined in claim 10,
said method comprising the step of reacting a chain extended silicone polymer or copolymer of the formula II
CE_{P}-[SP-CE]ₒ-SP₍₁₋ₚ₎ (II)
as defined in claim 6 with a compound of the formula (VII)
X—Y (VII)
wherein X is selected from the group consisting of —C≡CH, —N₃, —COOH, —OH, —SH, —NH₂, —SO₂, —PO₃, alkyl, cycloalkyl, heterocycloalkyl, aryl and heteroaryl, wherein said alkyl, cycloalkyl, heterocycloalkyl, aryl, heteroaryl may be substituted by one or more substituents selected from the group consisting of —CN, —F, —Cl, —Br, —I, —OH, —SH, —NH₂, —NO₂, —NCO, C₁₋₆-alkyl, C₂₋₆-alkenyl, and C₂₋₆-alkynyl; and
Y is a functional group;
or X and Y taken together form NR⁷R⁸R⁹, wherein R⁷, R⁸ and R⁹ are alkyl, or X and Y together form a cycloalkyl, heterocycloalkyl or heteroaryl group, wherein said alkyl, cycloalkyl, heterocycloalkyl or heteroaryl group may be substituted by one or more substituents selected from the group consisting of —CN, —F, —Cl, —Br, I, —OH, —SH, —NH₂, —NO₂, —NCO, C₁₋₆-alkyl, C₂₋₆-alkenyl, and C₂₋₆-alkynyl;
to obtain the functionalized chain extended silicone polymer or copolymer of the formula (V).

15. A method for preparing a crosslinked silicone elastomer comprising the steps of reacting a chain extender of the formula (I), a silicone polymer or copolymer of the formula (IV), and a crosslinker in a manner known per se.

16. A method for preparing a crosslinked silicone elastomer comprising the step of reacting a chain extended silicone polymer or copolymer of the formula (II) according to claim 6 with a crosslinker in a manner known per se.

17. A method for preparing a crosslinked functionalized silicone elastomer comprising the step of reacting a functionalized silicone polymer or copolymer according to claim 10 with a crosslinker in a manner known per se.

18. A use of a crosslinked functionalized silicone elastomer as electroactive elastomer.
